(19) United States
(12) Patent Application Publication
(10) Pub. No.: US 2024/0342995 A1
(43) Pub. Date: Oct. 17, 2024

(54) SYSTEMS AND METHODS FOR DESIGNING OBJECTS

(71) Applicant: Align Technology, Inc., San Jose, CA (US)

(72) Inventors: Nilesh Joshi, Cary, NC (US); Shaoming Wang, Cary, NC (US); Viswanath Meenakshisundaram, Santa Clara, CA (US); Jessica H. Schiltz, San Jose, CA (US); Bastien Pesenti, San Jose, CA (US); Jivtesh Khurana, San Jose, CA (US); Johan Andruejol, Chapel Hill, NC (US)

(21) Appl. No.: 18/634,302

(22) Filed: Apr. 12, 2024

Related U.S. Application Data
(60) Provisional application No. 63/508,627, filed on Jun. 16, 2023.
(60) Provisional application No. 63/496,078, filed on Apr. 14, 2023.

(51) Int. Cl. B29C 64/386; A61C 7/00; A61C 7/08; B29C 64/188; B29C 64/30; B29L 31/00; B33Y 10/00; B33Y 40/00; B33Y 40/20; B33Y 50/00; B33Y 80/00

(52) U.S. Cl. CPC B29C 64/386; A61C 7/002; A61C 7/08; B29C 64/188; B29C 64/30; B33Y 10/00; B33Y 40/00; B33Y 40/20; B33Y 50/00; B33Y 80/00; B29L 2031/7536

(57) ABSTRACT

Systems and methods for designing additively manufactured objects are provided. In some embodiments, a method includes receiving a treatment plan for a patient's teeth, and determining a set of appliance parameters for a dental appliance configured to implement the treatment plan. The method can also include determining a set of manufacturing parameters for a fabrication system to be used to additively manufacture the dental appliance. The method can further include generating a 3D digital representation of an appliance geometry for the dental appliance. The appliance geometry can be configured to mitigate loss of fidelity at a target region of the dental appliance due to at least one manufacturing parameter of the fabrication system.

### CROSS-REFERENCE TO RELATED APPLICATION(S)

The present application claims the benefit of priority to U.S. Provisional Application No. 63/496,078, filed Apr. 14, 2023, and U.S. Provisional Application No. 63/508,627, filed Jun. 16, 2023, the disclosures of which are incorporated by reference herein in their entirety.

### TECHNICAL FIELD

The present technology generally relates to manufacturing, and in particular, to systems and methods for designing objects for additive manufacturing.

### BACKGROUND

Additive manufacturing encompasses a variety of technologies that involve building up 3D objects from multiple layers of material. Batch production of additively manufactured objects typically involves creating a 3D model of each object, generating a digital layout of a batch of objects, converting the digital layout into a series of slices, then sequentially printing the slices to build up the objects in a layer-by-layer manner. The dimensional accuracy of a printed object is constrained by the capabilities of the additive manufacturing system used to fabricate the object, which may result in a resolution lower than the resolution of the initial 3D model of the object. The final object geometry can also be affected by digital inputs and physical outputs of additive manufacturing and post-processing. Conventional software for design, layout, and slicing of additively manufactured objects may lack the capability to compensate for printer-specific capabilities, post-processing conditions, and/or other manufacturing considerations that can affect the dimensional accuracy. Accordingly, the actual geometry of the printed object may deviate from the initial object design, which can detrimentally affect the function and properties of the printed object.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1 is a partially schematic diagram providing a general overview of an additive manufacturing process, in accordance with embodiments of the present technology.

FIG. 2 is a flow diagram providing a general overview of a method for fabricating and post-processing an additively manufactured object, in accordance with embodiments of the present technology.

FIG. 3A is a perspective view of a patient's dentition with attachments, in accordance with embodiments of the present technology.

FIG. 3B is a perspective view of an attachment placement device on the dentition of FIG. 3A, in accordance with embodiments of the present technology.

FIGS. 4A and 4B illustrate loss of fidelity in 2D cross-sections due to limitations in resolution for projector-based additive manufacturing.

FIGS. 4C-4E illustrate loss of fidelity in a 3D portion of an object due to vat polymerization printing techniques.

FIGS. 4F and 4G illustrate the effects of print directionality on printability of various object-support geometries.

FIG. 5 is a schematic diagram illustrating a treatment planning and appliance design ecosystem, in accordance with embodiments of the present technology.

FIG. 6 is a flow diagram providing a high-level overview of a workflow for designing and fabricating dental appliances, in accordance with embodiments of the present technology.

FIG. 7 is a flow diagram illustrating various types of data associated with an appliance design system, in accordance with embodiments of the present technology.

FIG. 8 is a flow diagram illustrating a method for designing a dental appliance, in accordance with embodiments of the present technology.

FIG. 9 illustrates a design for a target region of an additively manufactured object that compensates for overcuring, in accordance with embodiments of the present technology.

FIG. 10 is a flow diagram illustrating a method for fabricating a plurality of dental appliances, in accordance with embodiments of the present technology.

FIGS. 11A-11C illustrate a representative example of a digital layout based on print priority identifiers, in accordance with embodiments of the present technology.

FIG. 12A illustrates a representative example of a tooth repositioning appliance configured in accordance with embodiments of the present technology.

FIG. 12B illustrates a tooth repositioning system including a plurality of appliances, in accordance with embodiments of the present technology.

FIG. 12C illustrates a method of orthodontic treatment using a plurality of appliances, in accordance with embodiments of the present technology.

FIG. 13 illustrates a method for designing an orthodontic appliance, in accordance with embodiments of the present technology.

FIG. 14 illustrates a method for digitally planning an orthodontic treatment and/or design or fabrication of an appliance, in accordance with embodiments of the present technology.

### DETAILED DESCRIPTION

The present technology relates to systems and methods for designing additively manufactured objects, such as dental appliances (e.g., aligners, palatal expanders, retainers, attachment placement devices, attachments, oral sleep apnea appliances, mouth guards). In some embodiments, for example, a method includes receiving a treatment plan for a patient's teeth, the treatment plan including a target arrangement for the teeth and a plurality of treatment stages configured to reposition the teeth from an initial arrangement toward the target arrangement. The method can include determining a set of appliance parameters for a dental appliance configured to implement at least one treatment stage of the treatment plan. The method can further include determining a set of manufacturing parameters for a fabrication system to be used to additively manufacture the dental appliance. For example, the manufacturing parameters can represent constraints, capabilities, and/or conditions of an additive manufacturing process implemented by the fabrication system, such as print resolution (e g, minimum or maximum feature size, layer height, unsupported regions), print directionality (e.g., movement direction of the printer assembly, direction of forces applied to the object during printing and/or post-processing), predicted extent of material solidification or transformation (e.g., overcuring and/or undercuring), etc. Alternatively or in combination, the manufacturing parameters can represent post-processing conditions, such as deformation of the object, loss of material, change in material properties, and/or presence of residual material.

In some embodiments, the method includes generating a 3D digital representation of an appliance geometry for the dental appliance, based on the appliance parameters and/or manufacturing parameters. The appliance geometry can be configured to mitigate loss of fidelity (e.g., undesired changes in size, shape, and/or location) at a target region of the dental appliance due to at least one manufacturing parameter of the fabrication system. For example, the target region can be one or more portions of the dental appliance that are significant for clinical efficacy (e.g., accurately applying forces to teeth), proper positioning (e g, maintaining an attachment or other appliance feature at a desired spatial location), ergonomics (e.g., proper fit of the appliance of the patient's teeth, patient comfort), and/or other aspects of appliance function. The appliance geometry can be designed to reduce or minimize deviations between the intended size, shape, and/or location of the target region in the dental appliance, and the actual size, shape, and/or location of the target region during additive manufacturing and/or post-processing of the dental appliance.

Subsequently, the 3D digital representation of the appliance geometry can be converted into a plurality of 2D cross-sections (e.g., slices), which can be used to generate instructions to cause the fabrication system to additively manufacture the dental appliance having the appliance geometry in a layer-by-layer manner. Optionally, the method can include generating instructions to cause the fabrication system to additively manufacture a plurality of dental appliance concurrently in a single batch, by combining the 2D cross-sections of each appliance into a single digital layout.

The present technology can provide numerous advantages compared to conventional systems and methods for designing additively manufactured objects. For instance, conventional design software may not be “printer or process aware,” in that such software typically fails to consider the capabilities of the fabrication system when designing the additively manufactured object. Instead, conventional design software may simply output a 3D shape for the object, without compensating for loss of fidelity in shape, size, and/or location that may occur during slicing, layout, additive manufacturing, and/or post-processing of the object. If the loss of fidelity is significant and/or occurs at critical regions of the object, the object may fail to print or may be unsuitable for its intended function. The present technology can overcome these and other challenges by evaluating how the capabilities of the fabrication system may affect the final object geometry, and by making the appropriate adjustments during the 3D design process to mitigate loss of fidelity at critical regions. Accordingly, the approaches herein can avoid the need for tedious manual adjustments to the object design to provide the desired function, reduce print failure rates, and/or allow for large scale manufacturing of objects requiring highly precise and/or highly variable (e.g., patient-specific) shapes.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

### I. Overview of Additive Manufacturing Technology

The embodiments provided herein are suitable for designing dental appliances and/or other objects for fabrication via an additive manufacturing technique. Additive manufacturing (also referred to herein as “3D printing”) includes a variety of technologies which fabricate 3D objects directly from digital models through an additive process. In some embodiments, additive manufacturing includes depositing a precursor material onto a build platform. The precursor material can be cured, polymerized, melted, sintered, fused, and/or otherwise solidified to form a portion of the object and/or to combine the portion with previously formed portions of the object. In some embodiments, the additive manufacturing techniques provided herein build up the object geometry in a layer-by-layer fashion, with successive layers being formed in discrete build steps. Alternatively or in combination, the additive manufacturing techniques described herein can allow for continuous build-up of an object geometry.

Examples of additive manufacturing techniques include, but are not limited to, the following: (1) vat photopolymerization, in which an object is constructed from a vat or other bulk source of liquid photopolymer resin, including techniques such as stereolithography (SLA), digital light processing (DLP), continuous liquid interface production (CLIP), two-photon induced photopolymerization (TPIP), and volumetric additive manufacturing; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) material extrusion, in which material is drawn though a nozzle, heated, and deposited layer-by-layer, such as fused deposition modeling (FDM) and direct ink writing (DIW); (5) powder bed fusion, including techniques such as direct metal laser sintering (DMLS), electron beam melting (EBM), selective heat sintering (SHS), selective laser melting (SLM), and selective laser sintering (SLS); (6) sheet lamination, including techniques such as laminated object manufacturing (LOM) and ultrasonic additive manufacturing (UAM); and (7) directed energy deposition, including techniques such as laser engineering net shaping, directed light fabrication, direct metal deposition, and 3D laser cladding. Optionally, an additive manufacturing process can use a combination of two or more additive manufacturing techniques and/or can be used in conjunction with conventional subtractive manufacturing.

For example, the additively manufactured object can be fabricated using vat photopolymerization process in which light is used to selectively cure a vat or other bulk source of a curable material (e.g., a polymeric resin). Each layer of curable material can be selectively exposed to light in a single exposure (e.g., DLP) or by scanning a beam of light across the layer (e.g., SLA). Vat polymerization can be performed in a “top-down” or “bottom-up” approach, depending on the relative locations of the material source, light source, and build platform.

As another example, the additively manufactured object can be fabricated using high temperature lithography (also known as “hot lithography”). High temperature lithography can include any photopolymerization process that involves heating a photopolymerizable material (e.g., a polymeric resin). For example, high temperature lithography can involve heating the material to a temperature of at least 30° C., 40° C., 50° C., 60° C., 70° C., 80° C., 90° C., 100° C., 110° C., or 120° C. In some embodiments, the material is heated to a temperature within a range from 50° C. to 120° C., from 90° C. to 120° C., from 100° C. to 120° C., from 105° C. to 115° C., or from 105° C. to 110° C. The heating can lower the viscosity of the photopolymerizable material before and/or during curing, and/or increase reactivity of the photopolymerizable material. Accordingly, high temperature lithography can be used to fabricate objects from highly viscous and/or poorly flowable materials, which, when cured, may exhibit improved mechanical properties (e.g., stiffness, strength, stability) compared to other types of materials. For example, high temperature lithography can be used to fabricate objects from a material having a viscosity of at least 5 Pa-s, 10 Pa-s, 15 Pa-s, 20 Pa-s, 30 Pa-s, 40 Pa-s, or 50 Pa-s at 20° C. Representative examples of high-temperature lithography processes that may be incorporated in the methods herein are described in International Publication Nos. WO 2015/075094, WO 2016/078838, WO 2018/032022, WO 2020/070639, WO 2021/130657, and WO 2021/130661, the disclosures of each of which are incorporated herein by reference in their entirety.

In some embodiments, the additively manufactured object is fabricated using continuous liquid interphase production (also known as “continuous liquid interphase printing”) in which the object is continuously built up from a reservoir of photopolymerizable resin by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Representative examples of continuous liquid interphase production processes that may be incorporated in the methods herein are described in U.S. Patent Publication Nos. 2015/0097315, 2015/0097316, and 2015/0102532, the disclosures of each of which are incorporated herein by reference in their entirety.

As another example, a continuous additive manufacturing method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474 and U.S. Patent Publication No. 2014/0061974, the disclosures of which are incorporated herein by reference in their entirety. In another example, a continuous additive manufacturing method can involve extruding a composite material composed of a curable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety. In yet another example, a continuous additive manufacturing method can utilize a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

In a further example, the additively manufactured object can be fabricated using a volumetric additive manufacturing (VAM) process in which an entire object is produced from a 3D volume of resin in a single print step, without requiring layer-by-layer build up. During a VAM process, the entire build volume is irradiated with energy, but the projection patterns are configured such that only certain voxels will accumulate a sufficient energy dosage to be cured. Representative examples of VAM processes that may be incorporated into the present technology include tomographic volumetric printing, holographic volumetric printing, multiphoton volumetric printing, and xolography. For instance, a tomographic VAM process can be performed by projecting 2D optical patterns into a rotating volume of photosensitive material at perpendicular and/or angular incidences to produce a cured 3D structure. A holographic VAM process can be performed by projecting holographic light patterns into a stationary reservoir of photosensitive material. A xolography process can use photoswitchable photoinitiators to induce local polymerization inside a volume of photosensitive material upon linear excitation by intersecting light beams of different wavelengths. Additional details of VAM processes suitable for use with the present technology are described in U.S. Pat. No. 11,370,173, U.S. Patent Publication No. 2021/0146619, U.S. Patent Publication No. 2022/0227051, International Publication No. WO 2017/115076, International Publication No. WO 2020/245456, International Publication No. WO 2022/011456, and U.S. Provisional Patent Application No. 63/181,645, the disclosures of each of which are incorporated herein by reference in their entirety.

In yet another example, the additively manufactured object can be fabricated using a powder bed fusion process (e.g., selective laser sintering) involving using a laser beam to selectively fuse a layer of powdered material according to a desired cross-sectional shape in order to build up the object geometry. As another example, the additively manufactured object can be fabricated using a material extrusion process (e.g., fused deposition modeling) involving selectively depositing a thin filament of material (e.g., thermoplastic polymer) in a layer-by-layer manner in order to form an object. In yet another example, the additively manufactured object can be fabricated using a material jetting process involving jetting or extruding one or more materials onto a build surface in order to form successive layers of the object geometry (e.g., inkjet printing).

The additively manufactured object can be made of any suitable material or combination of materials. As discussed above, in some embodiments, the additively manufactured object is made partially or entirely out of a polymeric material, such as a curable polymeric resin. The resin can be composed of one or more monomer components that are initially in a liquid state. The resin can be in the liquid state at room temperature (e.g., 20° C.) or at an elevated temperature (e.g., a temperature within a range from 50° C. to 120° C.). When exposed to energy (e.g., light), the monomer components can undergo a polymerization reaction such that the resin solidifies into the desired object geometry. Representative examples of curable polymeric resins and other materials suitable for use with the additive manufacturing techniques herein are described in International Publication Nos. WO 2019/006409, WO 2020/070639, and WO 2021/087061, the disclosures of each of which are incorporated herein by reference in their entirety.

Optionally, the additively manufactured object can be fabricated from a plurality of different materials (e.g., at least two, three, four, five, or more different materials). The materials can differ from each other with respect to composition, curing conditions (e.g., curing energy wavelength), material properties before curing (e.g., viscosity), material properties after curing (e.g., stiffness, strength, transparency), and so on. In some embodiments, the additively manufactured object is formed from multiple materials in a single manufacturing step. For instance, a multi-tip extrusion apparatus can be used to selectively dispense multiple types of materials from distinct material supply sources in order to fabricate an object from a plurality of different materials. Examples of such methods are described in U.S. Pat. No. 6,749,414 and U.S. Pat. No. 11,318,667, the disclosures of which are incorporated herein by reference in their entirety. Alternatively or in combination, the additively manufactured object can be formed from multiple materials in a plurality of sequential manufacturing steps. For instance, a first portion of the object can be formed from a first material in accordance with any of the fabrication methods herein, then a second portion of the object can be formed from a second material in accordance with any of the fabrication methods herein, and so on, until the entirety of the object has been formed.

FIG. 1 is a partially schematic diagram providing a general overview of an additive manufacturing process, in accordance with embodiments of the present technology. In the illustrated embodiment, an object 102 is fabricated on a build platform 104 from a series of cured material layers, with each layer having a geometry corresponding to a respective cross-section of the object 102. To fabricate an individual object layer, a layer of curable material 106 (e.g., polymerizable resin) is brought into contact with the build platform 104 (when fabricating the first layer of the object 102) or with the previously formed portion of the object 102 on the build platform 104 (when fabricating subsequent layers of the object 102). In some embodiments, the curable material 106 is formed on and supported by a substrate (not shown), such as a film. Energy 108 (e.g., light) from an energy source 110 (e.g., a laser, projector, or light engine) is then applied to the curable material 106 to form a cured material layer 112 on the build platform 104 or on the object 102. The remaining curable material 106 can then be moved away from the build platform 104 (e.g., by lowering the build platform 104, by moving the build platform 104 laterally, by raising the curable material 106, and/or by moving the curable material 106 laterally), thus leaving the cured material layer 112 in place on the build platform 104 and/or object 102. The fabrication process can then be repeated with a fresh layer of curable material 106 to build up the next layer of the object 102.

The illustrated embodiment shows a “top down” configuration in which the energy source 110 is positioned above and directs the energy 108 down toward the build platform 104, such that the object 102 is formed on the upper surface of the build platform 104. Accordingly, the build platform 104 can be incrementally lowered relative to the energy source 110 as successive layers of the object 102 are formed. In other embodiments, however, the additive manufacturing process of FIG. 1 can be performed using a “bottom up” configuration in which the energy source 110 is positioned below and directs the energy 108 up toward the build platform 104, such that the object 102 is formed on the lower surface of the build platform 104. Accordingly, the build platform 104 can be incrementally raised relative to the energy source 110 as successive layers of the object 102 are formed.

Although FIG. 1 illustrates a representative example of an additive manufacturing process, this is not intended to be limiting, and the embodiments described herein can be adapted to other types of additive manufacturing systems (e.g., vat-based systems) and/or other types of additive manufacturing processes (e.g., material jetting, binder jetting, material extrusion, powder bed fusion, sheet lamination, directed energy deposition).

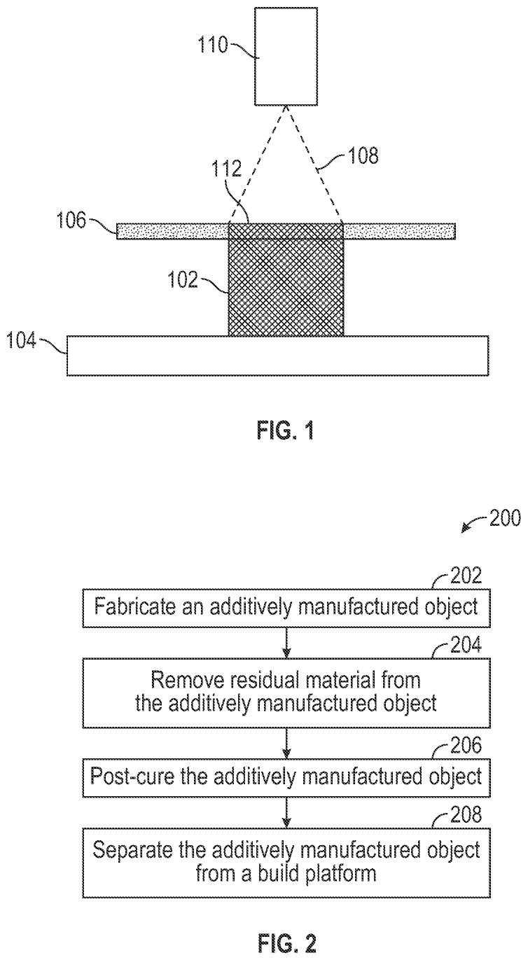

FIG. 2 is a flow diagram providing a general overview of a method 200 for fabricating and post-processing an additively manufactured object, in accordance with embodiments of the present technology. The method 200 can be performed using any embodiment of the systems and devices described herein. The method 200 begins at block 202 with fabricating an additively manufactured object, using any of the processes described herein. After the additively manufactured object is fabricated, the object can undergo one or more additional process steps, also referred to herein as “post-processing.” As described in detail below with respect to blocks 204-208, post-processing can include removing residual material from the object, curing the object, and/or separating the object from the build platform.

For example, at block 204, the method 200 continues with removing residual material from the additively manufactured object. The excess material can include excess precursor material (e.g., uncured resin) and/or other unwanted material (e.g., debris) that remains on or within the object after the additive manufacturing process. The residual material can be removed in many different ways, such as by exposing the object to a solvent (e.g., via spraying, immersion), heating or cooling the object, applying a vacuum to the object, blowing a pressurized gas onto the object, applying mechanical forces to the object (e.g., vibration, agitation, centrifugation, tumbling, brushing), and/or other suitable techniques. Optionally, the residual material can be collected and/or processed for reuse.

At block 206, the method 200 can optionally include post-curing the object. Post-curing is an additional curing step that can be used in situations where the object is still in a partially cured “green” state after fabrication. For example, the energy used to fabricate the object in block 202 may only partially polymerize the precursor material forming the object. Accordingly, the post-curing step may be needed to fully cure (e.g., fully polymerize) the object to its final, usable state. Post-curing can provide various benefits, such as improving the mechanical properties (e.g., stiffness, strength) and/or temperature stability of the object, which can improve the resistance of the object to deformation. Post-curing can be performed by applying radiation (e.g., infrared (thermal), UV, visible, microwave) to the object, chemical exposure, mechanical inputs (e.g., direct force, pressure), or suitable combinations thereof. In other embodiments, however, the post-curing process of block 206 is optional and can be omitted.

At block 208, the method 200 can optionally include separating the additively manufactured object from a build platform. The build platform can be a plate, sheet, printer bed, or other feature or component that mechanically supports the object during fabrication and/or the post-processing steps described herein. The build platform can be made of the same material as the object or can be made of a different material than the object. In some embodiments, the object includes a functional portion that is intended to be in the final product, and a sacrificial portion (e.g., a raft and/or support structures) that is not intended to be in the final product. The sacrificial portion can temporarily connect the functional portion to the build platform during fabrication and post-processing. Accordingly, the process of block 208 can include separating the sacrificial portion from the functional portion of the object and/or from the build platform via mechanical techniques (e.g., fracturing), thermal techniques (e.g., heating or cooling), chemical techniques (e.g., dissolution in solvent), or suitable combinations thereof.

The method 200 illustrated in FIG. 2 can be modified in many different ways. For example, although the above steps of the method 200 are described with respect to a single object, the method 200 can be used to sequentially or concurrently fabricate and post-process any suitable number of objects, such as tens, hundreds, or thousands of serial or unique additively manufactured objects. As another example, the ordering of the processes shown in FIG. 2 can be varied (e.g., the process of block 208 can be performed before and/or concurrently with the processes of blocks 204 and/or 206). Some of the processes of the method 200 can be omitted, such as the process of block 206.

Additionally, the method 200 can include processes not shown in FIG. 2, such as cleaning the object (e.g., washing with water, solvents, etc.), annealing the object, trimming the object to remove structures that are not intended to be present in the final product (e.g., residual parts of the support structures), and/or packaging the object for shipment. Optionally, the method 200 can include modifying at least one surface, volume, and/or cavity of the object. The modifications can be applied to some or all of the surfaces, volumes, and/or cavities of the object (e.g., exterior and/or interior regions) to alter one or more characteristics, such as the surface finish (e.g., roughness, waviness, lay), porosity, visual appearance (e.g., gloss, transparency, visibility of print lines), hydrophobicity, and/or chemical reactivity. In some embodiments, the modifications include removing material from the object, e.g., by polishing, abrading, blasting, etc. Alternatively or in combination, the modifications can include applying, infiltrating, and/or extracting an additional material to and/or from the object. For example, the additional material can be a coating, such as a polymeric coating. The coating can be applied to one or more surfaces of the object for various purposes, including, but not limited to: providing a smooth surface finish, which can be beneficial for aesthetics and/or to improve user comfort if the object is intended to be in contact with the user's body (e.g., a dental appliance worn on the teeth); coloring and/or applying other aesthetic features to the object; improving scratch resistance and/or other mechanical properties; providing antimicrobial properties; and incorporating therapeutic agents into the object for controlled release.

### II. Systems and Methods for Designing Objects with High Manufacturing Fidelity

Additive manufacturing techniques can be used to design and fabricate many different types of dental appliances, such as aligners, palatal expanders, retainers, attachment placement devices, oral sleep apnea appliances, mouth guards, etc. Certain types of dental appliances can have small and/or detailed features with strict manufacturing tolerances. Regions of the dental appliance that are important or necessary for certain functions (e.g., clinical efficacy, proper positioning, ergonomics, mechanical properties, aesthetics) may also be subject to strict tolerances. For example, the tolerance for certain features and/or regions of a dental appliance can be less than or equal to 500 μm, 200 μm, 100 μm, 50 μm, 20 μm, or 10 μm. If there is significant loss of fidelity in such features and/or regions during the manufacturing process—for instance, if the actual size, shape, and/or location of the features and/or regions deviates from the intended size, shape, and/or location by more than the tolerance—the appliance may fail to manufacture properly and/or may be unsuitable for its intended function.

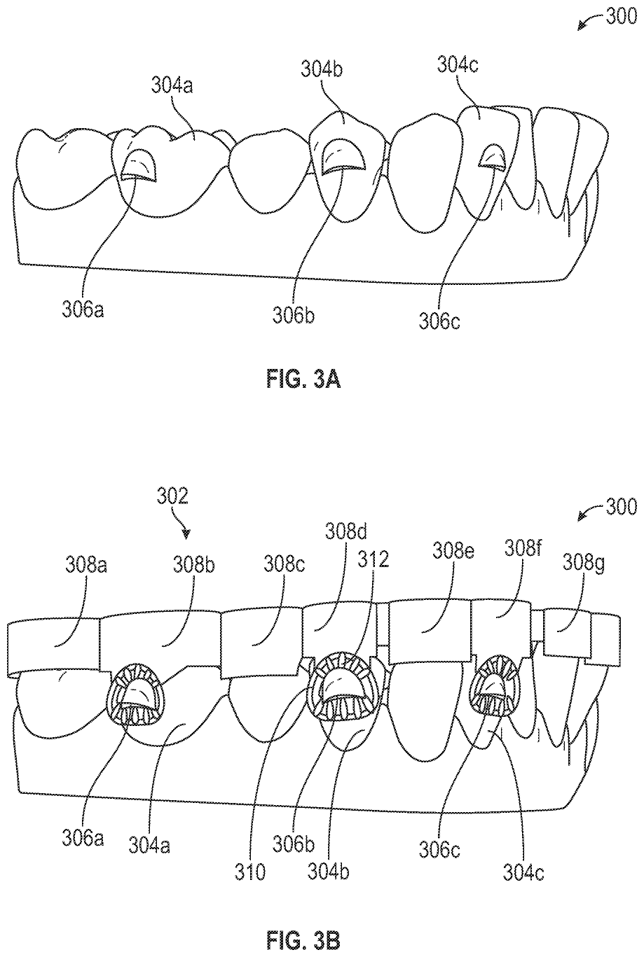

As a representative example, FIG. 3A is a perspective view of a patient's dentition 300, and FIG. 3B is a perspective view of an attachment placement device (“device 302”) on the dentition 300, in accordance with embodiments of the present technology. Referring first to FIG. 3A, the dentition 300 includes one or more teeth (e.g., a first tooth 304a, second tooth 304b, and third tooth 304c—collectively, “teeth 304”) each having a respective attachment mounted thereon (e.g., a first attachment 306a, a second attachment 306b, and a third attachment 306c—collectively, “attachments 306”). The attachments 306 can be designed to engage with portions of an orthodontic appliance (e.g., an aligner) to apply forces to the teeth 304 in accordance with an orthodontic treatment plan. The attachments 306 can be placed at predetermined locations on the teeth 304 in order to apply appropriate forces (e.g., in magnitude and/or direction) in accordance with part of the treatment plan.

Referring next to FIG. 3B, the device 302 can be used to properly place the attachments 306 so that they can cooperate with the orthodontic appliance to apply the correct forces on the dentition 300. The device 302 can include a body having a plurality of registration portions 308a-308g (collectively, “registration portions 308”) that are configured to mate with surfaces of the patient's teeth. In some embodiments, some or all of the registration portions 308 include one or more cavities shaped to receive a corresponding one or more teeth to retain the device 302 in a specified spatial configuration with respect to the dentition 300.

In the illustrated embodiment, each attachment 306 can be coupled to a frame 310 via a plurality of supports 312, and the frame 310 can be connected to the registration portion 308 (also known as a “registration element” or “registration anchor”). In some embodiments, the attachment 306 is prefabricated together with the frame 310, supports 312, and registration portion 308, such that the attachment 306 is formed in situ within the frame 310 and coupled to the supports 312. The attachment 306, frame 310, supports 312, and registration portions 308 can be fabricated in the same manufacturing process (e.g., a single additive manufacturing operation). The attachments 306 can be spatially positioned relative to the registration portions 308 such that when the registration portions 308 are placed on the dentition 300, the attachments 306 are properly aligned with respect to the corresponding teeth 304 for bonding.

The supports 312 can be a plurality of elongate members (e.g., struts, rods) that surround and couple to the attachment 306. The supports 312 can be configured to maintain the attachment 306 in position within the frame 310. In some embodiments, the attachment 306 and the supports 312 are bonded, fused, joined, or integrally formed with each other, such that the attachment 306 is separated from the supports 312 by breaking the supports 312. Alternatively, the attachment 306 and supports 312 can be removably coupled to each other, so that the attachment 306 can be separated from the supports 312 without fracturing the supports 312.

As shown in FIG. 3B, the device 302 includes small, detailed features that may need to be printed with a high degree of dimensional accuracy. In some embodiments, the tolerances for the supports 312, the connection regions between the supports 312 and the corresponding attachments 306, and/or the exterior surfaces of the attachments 306 are less than or equal to 500 μm, 200 μm, 100 μm, 50 μm, 20 μm, or 10 μm. Deviations from these tolerances during fabrication of the device 302 may result in print failure. For instance, the supports 312 may deform or fracture, or may not connect properly to the attachment 306. Additionally, deviations from these tolerances may cause the device 302 to be unsuitable for its intended function. For example, one or more of the supports 312 may not break in a predictable way to release the respective attachment 306, one or more of the attachments 306 may be positioned at an incorrect location on the respective tooth 304, the attachments 306 may not fit properly with the orthodontic appliance, and/or the attachments 306 may not produce the proper forces against the teeth 304.

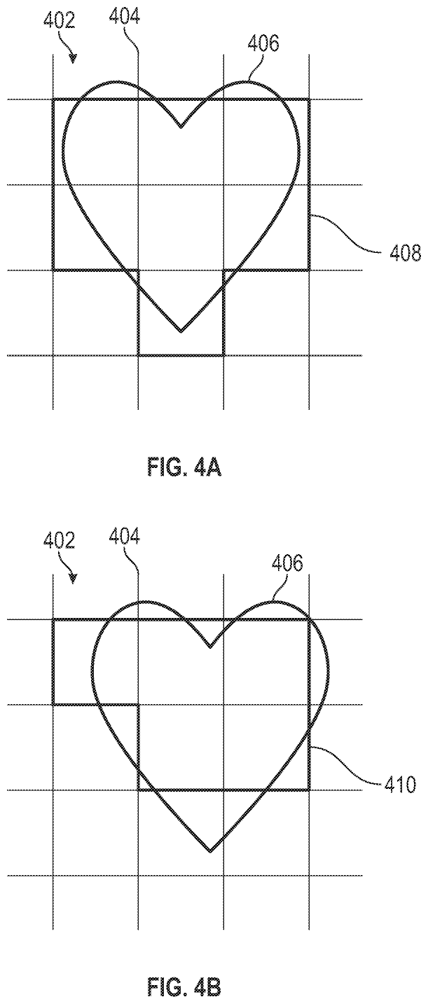

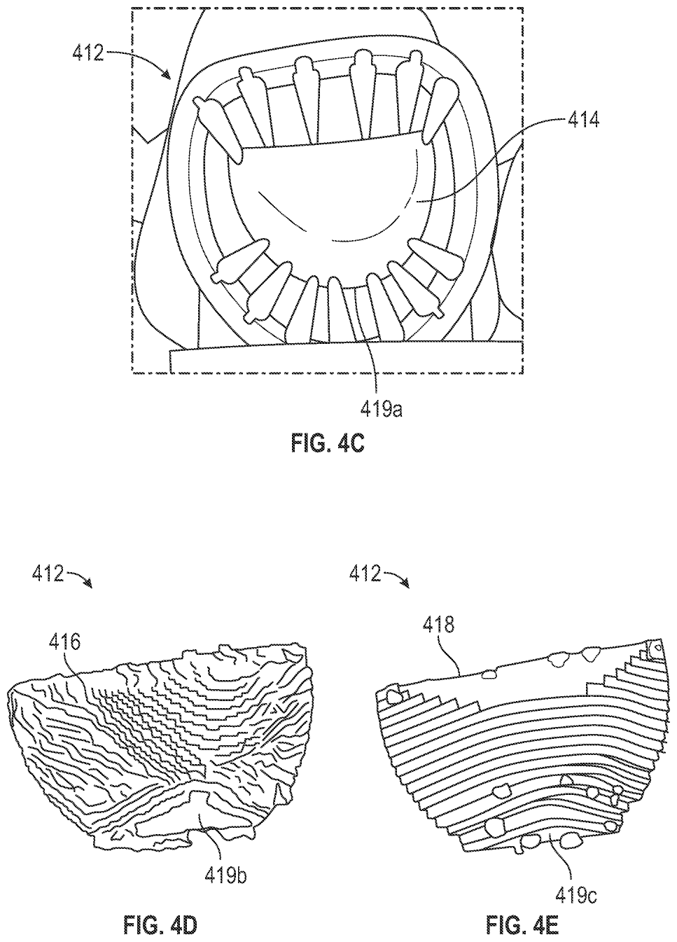

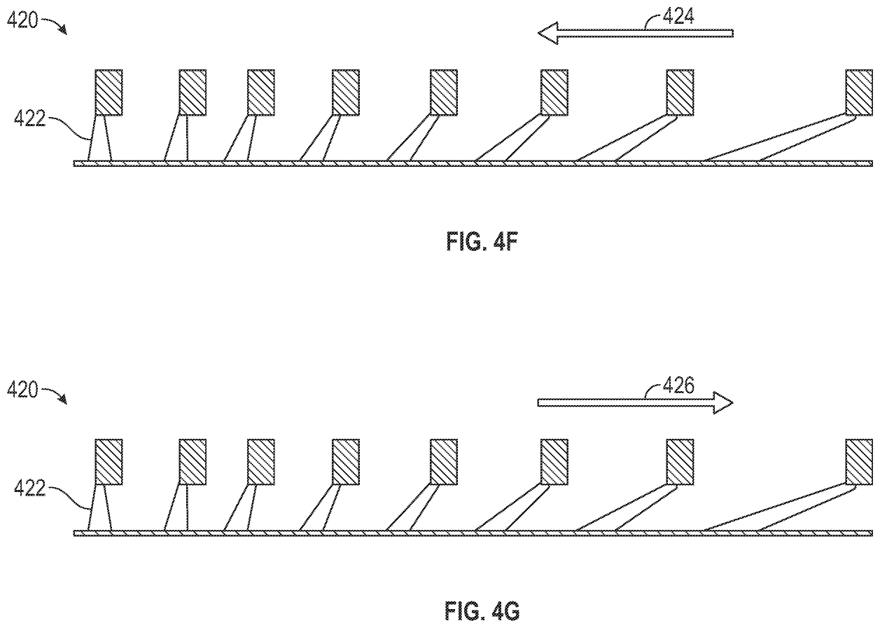

FIGS. 4A-4F illustrate representative examples of how loss of fidelity may occur during additive manufacturing. For instance, FIGS. 4A and 4B illustrate loss of fidelity in a 2D cross-section of an object 402 due to limitations in resolution for projector-based additive manufacturing. In some instances, the resolution of the digital model of the object 402 created during the design process is higher than the resolution of the additive manufacturing system that will be used to fabricate the object 402. Accordingly, shape information may be lost and/or the shape may become distorted when converting the model to the lower resolution of the additive manufacturing system (e.g., via rasterization and/or downsampling).

Referring first to FIG. 4A, coordinate grid 404 depicts the pixel size of a projector-based additive manufacturing system (e.g., a DLP system), which can correspond to the minimum horizontal resolution of the additive manufacturing system. As shown in FIG. 4A, the object 402 has an intended geometry 406 that is designed at higher resolution than the pixel size of the additive manufacturing system. Thus, loss of fidelity can occur when converting the intended geometry 406 of the object 402 to the resolution of the additive manufacturing system for printing, in that the actual geometry 408 of the object 402 deviates from the intended geometry 406 (e.g., the details of the outer shape of the intended geometry 406 are lost in the actual geometry 408).

Additional loss of fidelity can occur if the intended geometry 406 is not properly aligned with the coordinate grid 404 when converting to the lower print resolution. For example, the alignment between the object 402 and the coordinate grid 404 shown in FIG. 4A produces an actual geometry 408 that preserves the overall symmetrical shape of the object 402. In contrast, the alignment between the object 402 and the coordinate grid 404 shown in FIG. 4B produces an actual geometry 410 that is no longer symmetric. This variability in the resultant pixelated cross-section can add complexity to maintaining dimensional accuracy, mechanical behavior, and/or manufacturing yield.

FIGS. 4C-4E illustrate loss of fidelity in a 3D portion of an object 412 due to vat photopolymerization printing techniques. Specifically, FIG. 4C illustrates a digital model representing an intended geometry 414 for the object 412 (e.g., an attachment of an attachment placement device), FIG. 4D illustrates an actual geometry 416 of the object 412 when additively manufactured using a DLP technique, and FIG. 4E illustrates an actual geometry 418 of the object 412 when additively manufactured using an SLA technique. As shown in FIGS. 4D and 4E, the amount of shape information lost may vary between different printing techniques. For example, DLP techniques typically print based on square pixels, which may result in greater loss of shape information when printing curved shapes. SLA techniques typically print based on a circular spot, which may produce improved shape fidelity for curved shapes.

Moreover, loss of shape information can occur at the portions of the object 412 that are printed first. In some instances, the initial layer(s) of an object manufactured via a vat photopolymerization technique may have at least a minimum cross-sectional area to provide sufficient adhesion to the build platform and/or provide support for subsequent layers of the object. Thus, loss of shape fidelity may occur if the intended geometry 414 of the object 412 at the initial layer(s) does not have sufficient surface area for purposes of adhesion and/or support. For instance, in the illustrated embodiment, the lower portion 419a of the object 412 corresponds to the first printed layer of the object 412 and is intended to be a thin edge having little or no cross-sectional surface area. However, in the actual geometry 416 of the object 412 produced by DLP, the lower portion 419b is truncated into a flat surface having a larger cross-sectional surface area. A similar truncation is observed in the lower portion 419c in the actual geometry 418 of the object 412 produced by the SLA.

FIGS. 4F and 4G illustrate the effects of print directionality on printability of objects 420 with different object-support geometries. As shown in FIGS. 4F and 4E, each object 420 includes an elongate member 422 (e.g., a cone, strut, or other support structure) that can be arranged at various angles, representing a gradual increase in overhang (from left to right in the drawings). Referring first to FIG. 4F, arrow 424 represents the direction of forces (e.g., shear forces) applied to the objects 420 during additive manufacturing, which can correspond to the movement direction of the printer assembly or other component of the additive manufacturing system (e.g., a scraper blade that removes excess precursor material from the objects 420). In FIG. 4F, the elongate members 422 of the objects 420 are angled in a direction opposite the direction of the applied forces, which can produce improved printability of the objects 420 (e.g., the objects 420 are likely to print successfully with little or no deformation, fracturing, etc.).

Referring next to FIG. 4G, arrow 426 represents the direction of forces (e.g., shear forces) applied to the objects 420 during additive manufacturing, which can correspond to the movement direction of the printer assembly or other component of the additive manufacturing system. In FIG. 4G, the elongate members 422 of the objects 420 are angled in the same direction as the direction of the applied forces, which can produce poorer printability of the objects 420 (e.g., the objects 420 are likely to be deformed or fractured by applied forces during printing).

Loss of fidelity may also occur due to other aspects of the additive manufacturing process and/or post-processing operations. For instance, overbuild and/or overcure can occur when the precursor material used to form the object is cured to a greater extent than intended in the horizontal (e.g., x-y) dimension and/or the vertical (e.g., z) dimension, e.g., the actual geometry of the cured object portion (e.g., area and/or height) is larger than the intended geometry. As another example, one or more portions of an object can deform due to mechanical stresses, temperatures, solvents, and/or other conditions during additive manufacturing and/or post-processing. In a further example, material can be lost from one or more portions of an object due to solvents, mechanical abrasion, and/or other conditions during additive manufacturing and/or post-processing. In yet another example, excess material can become incorporated into one or more portions of an object during additive manufacturing and/or post-processing. For instance, residual precursor material that remains on the object may become unintentionally incorporated into the object after post-curing.

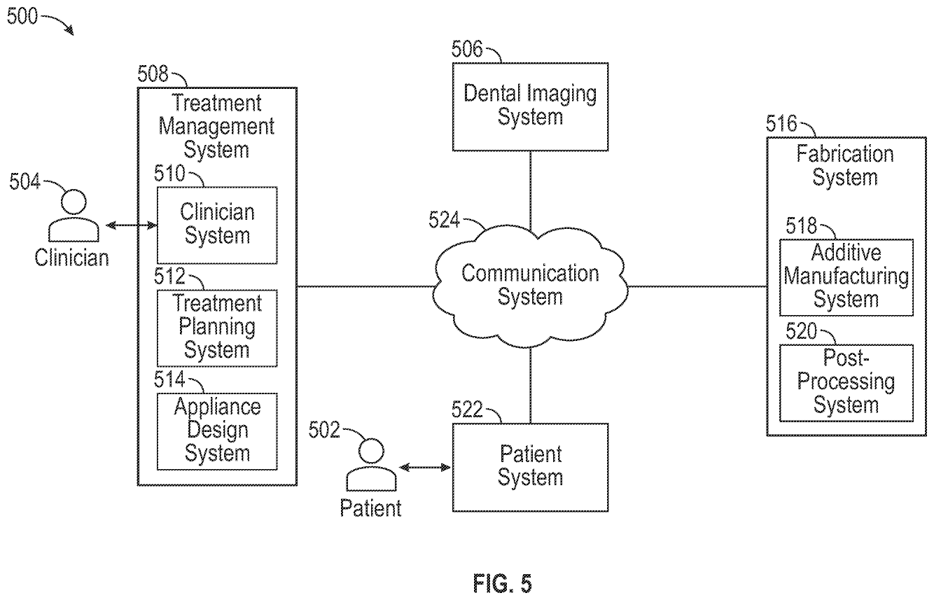

FIG. 5 is a schematic diagram illustrating a treatment planning and appliance design ecosystem (“ecosystem 500”), in accordance with embodiments of the present technology. The ecosystem 500 can be used to design any of the dental appliances described herein, and can be configured to implement techniques to mitigate loss of fidelity during additive manufacturing of such dental appliances. The ecosystem 500 includes a plurality of interconnected hardware and software components that perform some or all of the following operations planning and managing treatment of a patient 502, providing tools to allow a clinician 504 to submit a patient case for treatment and review treatment plans and/or appliance designs, generating digital designs of dental appliances for implementing a treatment plan, and/or direct fabrication of dental appliances via additive manufacturing. As shown in FIG. 5, the ecosystem 500 can include a dental imaging system 506, at least one treatment management system 508 (e.g., including a clinician system 510, a treatment planning system 512, and/or an appliance design system 514), at least one fabrication system 516 (e.g., an additive manufacturing system 518 and/or a post-processing system 520), a patient system 522, and/or a communication system 524.

The dental imaging system 506 is configured to obtain image data of a patient's dentition, intraoral cavity, and/or other relevant anatomical structures (e.g., craniofacial anatomy). The image data can be generated via any suitable imaging modality, and can include photographs, videos, scan data (e.g., intraoral and/or extraoral scans), magnetic resonance imaging (MRI) data, radiographic data (e.g., standard x-ray data such as bitewing x-ray data, panoramic x-ray data, cephalometric x-ray data, computed tomography (CT) data, cone-beam computed tomography (CBCT) data, fluoroscopy data), and/or motion data. The image data can include 2D data (e.g., 2D photographs or videos), 3D data (e.g., 3D photographs, intraoral and/or extraoral scans, digital models), 4D data (e.g., fluoroscopy data, dynamic articulation data, hard and/or soft tissue motion capture data), or suitable combinations thereof.

In some embodiments, for example, the dental imaging system 506 includes or is operably coupled to a scanner configured to obtain a 3D digital representation (e.g., images, surface topography data) of a patient's teeth, such as via direct intraoral scanning or indirectly via casts, impressions, models, etc. The scanner can include a probe (e.g., a handheld probe) for optically capturing 3D structures (e.g., by confocal focusing of an array of light beams). Examples of scanners include, but are not limited to, the iTero® intraoral digital scanner manufactured by Align Technology, Inc., the 3M True Definition Scanner, and the Cerec Omnicam manufactured by Sirona®.

In some embodiments, the dental imaging system 506 is configured to process the image data to generate a digital representation of the teeth of the patient 502. Alternatively, the dental imaging system 506 can transmit the image data to another component that generates the digital representation, such as the treatment planning system 512. The digital representation can be a 3D model, such as a mesh model or a surface model. Depending on the time the image data was collected, the digital representation can depict the patient's teeth in any suitable arrangement, such as an initial arrangement before the start of a treatment plan, an intermediate arrangement after treatment has commenced, or a final arrangement after the treatment has been completed.

The image data and/or digital representations of the teeth produced by the dental imaging system 506 can be used at various stages in the treatment planning and appliance design workflows described herein. For example, imaging can be performed before the start of treatment to provide the clinician 504 with an accurate depiction of the current state of the patient's teeth. The initial digital representation of the teeth can also be used as a basis for treatment planning and/or appliance design. Imaging can also be performed during the course of treatment so the clinician 504 can assess treatment progress and determine whether any modifications to the treatment plan are appropriate (e.g., whether new or modified appliances are needed). Additionally, imaging can be performed after completion of the treatment plan so the clinician 504 can assess the patient's outcome and determine whether further treatment would be beneficial (e.g., whether additional appliances are needed).

The treatment management systems 508 can include one or more systems configured to perform treatment planning and appliance design. In some embodiments, the treatment management systems 508 collectively implement an end-to-end workflow for receiving and reviewing a case for the patient 502 (e.g., an orthodontics and/or general practice case), determining a treatment prescription for the case, developing one or more treatment plans according to the treatment prescription, and/or generating designs for one or more dental appliances to implement the treatment plan(s). Additionally, the treatment management system 508 can interact with other components of the ecosystem 500 to facilitate treatment planning and appliance design. For example, the treatment management system 508 can receive image data from the dental imaging system 506, and can transmit files and/or instructions for manufacturing appliances to the fabrication system 516.

As shown in FIG. 5, the treatment management systems 508 can include a clinician system 510 associated with the clinician 504 (e.g., an orthodontist, dentist, doctor, or other healthcare provider). The clinician system 510 can provide a software portal allowing the clinician 504 to receive and access information for a patient 502, such as image data and/or digital representations of the patient's teeth produced by the dental imaging system 506, as well as any other relevant patient data. The software portal can allow the clinician 504 to create and submit a new patient case for treatment planning using the image data, digital representations, and/or other patient data.

In some embodiments, the clinician 504 provides input specifying various treatment parameters for the patient case, such as the treatment prescription (e.g., treatment goals), tooth information (e.g., which teeth should or should not be treated, the geometry of the teeth), movement information (e.g., movement direction, movement velocity, movement types such as distalization, root control compound movement, etc.), treatment protocols for specific types of malocclusions, staging for treatment procedures such as interproximal reduction (IPR), etc. The treatment parameters can specify one or more desired appliance features, such as attachments, attachment receptacles, appliance regions that contact the teeth (e.g., contact points, pressure points, power ridges), appliance regions that avoid contact with the teeth (e.g., bubbles, virtual fillers to provide clearance at interproximal regions), activations, bite ramps, mandibular advancement wings, and/or cutlines. For example, the treatment parameters can indicate any of the following: locations and/or shapes of attachments to be mounted on the patient's teeth; locations and/or shapes of attachment receptacles formed in the appliance to engage the attachments; locations and/or shapes of tooth-contacting regions; locations and/or shapes of non-tooth-contacting regions (e.g., curvature of virtual fillers to influence appliance engagement with the teeth); direction and/or magnitude of overcorrected tooth movements for activations; locations and/or shapes of bite ramps; locations and/or shapes of mandibular advancement wings; and/or locations and/or shapes of cutlines.

The case information can be transmitted to the treatment planning system 512 and/or the appliance design system 514 to produce treatment plans and/or appliance designs for the patient case, respectively. Subsequently, the clinician system 510 can receive the treatment plans and/or recommendations produced by the treatment planning system 512, and can allow the clinician 504 to review and provide feedback (e.g., approval, comments, modifications, selection of a treatment plan). The clinician system 510 can optionally receive appliance designs produced by the appliance design system 514, and can allow the clinician 504 to review and provide feedback (e.g., approval, comments, modifications, selection of an appliance design). In some embodiments, the clinician system 510 provides a user interface allowing the clinician 504 to visualize, review, and/or provide feedback on the patient's dentition, digital representations of the teeth, treatment plan, appliance designs, and/or other data relevant to the patient's case.

The treatment planning system 512 can generate one or more treatment plans for the patient case received from the clinician system 510. In some embodiments, for example, the treatment planning system 512 is configured to receive image data and/or a digital representation of an initial tooth arrangement of the patient 502 from the dental imaging system 506 and/or the clinician system 510, as well as the treatment prescription from the clinician system 510. The treatment planning system 512 can use the image data and/or digital representation to determine a target tooth arrangement to achieve the treatment goals specified by the treatment prescription. The treatment planning system 512 can then generate a treatment plan for achieving the target tooth arrangement, as described in greater detail below. Optionally, the treatment plan can be generated based on one or more treatment parameters that are received from the clinician system 510, determined by the treatment planning system 512, or suitable combinations thereof. The treatment plan can be manually generated by operators of the treatment planning system 512, automatically generated using real-time and/or automated software algorithms implemented by the treatment planning system 512, or suitable combinations thereof. Optionally, multiple treatment plans can be produced for a particular patient case, thus allowing the clinician 504 to compare different treatment options.

Once a treatment plan is generated, the treatment planning system 512 can send the treatment plan to the clinician system 510 for review by the clinician 504. If the clinician 504 provides modifications to the treatment plan, the treatment planning system 512 can receive and review the modifications, and update the treatment plan if appropriate. The updated treatment plan can then be sent back to the clinician system 510 for further review. This process can be repeated until the treatment plan is approved by the clinician 504.

The appliance design system 514 can receive an approved treatment plan from the treatment planning system 512 and/or other relevant inputs (e.g., digital representations of teeth, treatment parameters, treatment goals, material capabilities, features, fabrication process conditions). The appliance design system 514 can design one or more appliances (e.g., aligners, palatal expanders, retainers, attachment placement devices) that implement one or more treatment stages of the treatment plan. For example, the appliance design system 514 can generate a digital representation of the appliance geometry, such a 3D digital model (e.g., a surface model, mesh model, non-parametric model, parametric model). The 3D digital model can be provided in any suitable file format, such as a CAD file, STL file, OBJ file, AMF file, 3MF file, etc. The appliance geometry can be manually generated by operators of the appliance design system 514, automatically generated using real-time and/or automated software algorithms implemented by the appliance design system 514, or suitable combinations thereof. In some embodiments, multiple appliance geometries are produced for one or more treatment stages so the clinician 504 can select a desired appliance design after reviewing different options.

The digital representation of the appliance generated by the appliance design system 514 can be transmitted to other components of the ecosystem 500, such as the clinician system 510, treatment planning system 512, patient system 522, and/or fabrication system 516. In some embodiments, the digital representation is transmitted to the additive manufacturing system 518 as a set of instructions to control the additive manufacturing system 518 in fabricating the appliance. In embodiments where the additive manufacturing system 518 uses a layer-by-layer technique to fabricate the appliance, the digital representation can be converted from a 3D format into a plurality of 2D cross-sections (e.g., slices), and the 2D cross-sections can be used as the instructions for fabricating to the individual layers of the appliance, or can be used to generate such instructions. The 2D cross-sections can be provided in any suitable file format, such as a BMP file or a PNG file. The process of converting the 3D digital representation into 2D cross-sections (also referred to herein as “slicing”) can be performed by the appliance design system 514, the additive manufacturing system 518, or a combination thereof.

In some embodiments, the instructions for the additive manufacturing system 518 include or include a digital layout showing the spatial location of the appliance on the active print area and/or build platform. In embodiments where the additive manufacturing system 518 produces a plurality of appliances concurrently, the digital layout can be generated by combining 2D cross-sections from each appliance into a single layout file. The digital layout can also include other components besides the appliance(s), such as support structures (e.g., struts, crossbars, rafts, sidewalls) and/or reference structures (e.g., coupons). The process of generating the digital layout can be performed by the appliance design system 514, the additive manufacturing system 518, or a combination thereof.

The fabrication system 516 includes at least one additive manufacturing system 518 that directly fabricates appliances via an additive manufacturing process, based on the instructions from the appliance design system 514. Optionally, the fabrication system 516 can also include at least one post-processing system 520 for performing post-processing operations on the fabricated appliances, such as cleaning, post-curing, etc. The additive manufacturing process and post-processing operations can include any of the techniques described herein.

The patient system 522 can include hardware and/or software components that interface with the patient 502. For example, the patient system 522 can provide a software portal that allows the patient to communicate with the clinician 504 (e.g., online scheduling, locating clinicians). The patient 502 can also use the software portal to view the treatment plans, e.g., via a user interface that provides a visualization of planned and/or actual treatment outcomes. The patient system 522 can also allow the patient 502 to submit progress tracking and/or case assessment data, such as images of the patient's teeth obtained via a mobile device (e.g., smartphone) or camera. The patient system 522 can also provide tools for managing appliance ordering and/or shipment, as well as viewing related financial information.

The communication system 524 can be or include any suitable hardware and software components for operably coupling the various components of the ecosystem 500 to each other, and can include one or more buses, networks, runtime linkers that connect pieces of code, etc. For example, the communication system 524 can be or include a communication network, such as one or more of the following: a wired network, a wireless network, a metropolitan area network (MAN), a local area network (LAN), a wide area network (WAN), a virtual local area network (VLAN), an internet, an extranet, an intranet, and/or any other suitable type of network or combinations thereof.

Any of the components of the ecosystem 500 shown as distinct components in FIG. 5 can be combined and/or include interrelated code. Any of the components of the ecosystem 500 can be implemented as a single and/or interrelated piece of software, or as different pieces of software. Any of the components of the ecosystem 500 can be embodied on a single machine or any combination of multiple machines. For example, the clinician system 510, treatment planning system 512, and/or appliance design system 514 can be combined with each other and/or with other components such as the dental imaging system 506, fabrication system 516, and/or the patient system 522. Additionally, any of the treatment management systems 508 can share modules and/or devices with the fabrication system 516. Any of the treatment management systems 508 can provide software to visualize the appliance designs generated by the appliance design system 514. Optionally, the fabrication system 516 can include the appliance design system 514. The fabrication system 516 can be part of the treatment management systems 508, or can be a separate component.

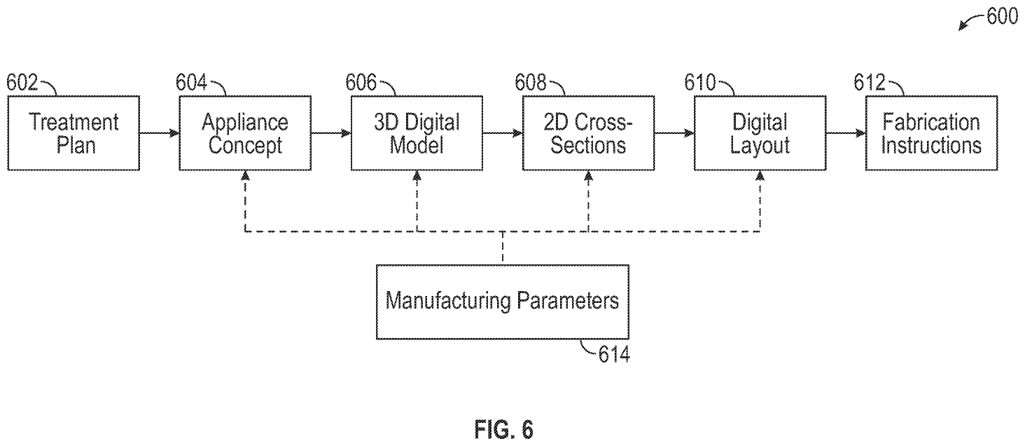

FIG. 6 is a flow diagram providing a high-level overview of a workflow 600 for designing and fabricating dental appliances, in accordance with embodiments of the present technology. The workflow 600 can be used to design appliances having geometries that avoid or otherwise mitigate loss of fidelity issues that may arise during additive manufacturing of the dental appliances. The workflow 600 can be implemented by any of the systems and devices described herein, such as any of the components of the ecosystem 500 of FIG. 5.

At block 602, the workflow 600 includes receiving a treatment plan for a patient's teeth. The treatment plan can include a target arrangement for the teeth and one or more treatment stages for achieving the target arrangement. For example, the treatment stages can be or include a series of intermediate tooth arrangements configured to incrementally reposition the teeth from an initial tooth arrangement toward the target tooth arrangement. The treatment plan can also include other relevant parameters, such as tooth information (e.g., which teeth should or should not be treated, the geometry of the teeth), movement information (e.g., movement direction, movement velocity, movement types such as distalization, root control compound movement, etc.), desired appliance features (e.g., attachments, attachment receptacles, tooth-contacting regions, non-tooth-contacting-regions, activations, bite ramps, mandibular advancement wings, and/or cutlines), treatment protocols for specific types of malocclusions, staging for treatment procedures, constraints, modifications, etc.

The treatment plan can be determined using any suitable computing system or device, such as the treatment planning system 512 of FIG. 5. The treatment plan can be manually generated by operators of the treatment planning system 512, automatically generated using real-time and/or automated software algorithms implemented by the treatment planning system 512, or suitable combinations thereof. In some embodiments, the treatment plan is generated based on a digital representation of a patient's teeth in the initial arrangement, such as intraoral scan data and/or other image data received from the dental imaging system 506 of FIG. 5. The digital representation of the initial tooth arrangement can be used to produce a plurality of digital representations corresponding to the target tooth arrangement and intermediate tooth arrangements.

At block 604, the treatment plan can be used to determine an appliance concept for a dental appliance configured to implement one or more stages of the treatment plan. The appliance concept can be or include a set of appliance parameters that provide rules, constraints, requirements, etc., for the geometry of the dental appliance. For example, for an aligner, the appliance parameters can define the geometry and locations of appliance features such as attachment receptacles, tooth-contacting regions, non-tooth-contacting-regions, activations, bite ramps, mandibular advancement wings, and/or cutlines. As another example, for an attachment placement device, the appliance parameters can define the geometry and locations of appliance features such as attachments, supports for the attachments, registration elements contacting the teeth, and/or connections between registration elements. The appliance parameters can include one or more of the following: maximum and/or minimum size of a feature (e.g., length, height, width, radius, circumference, thickness, volume, surface area); maximum and/or minimum spacing between neighboring features; maximum and/or minimum spacing between a feature and nearby anatomical structures (e.g., teeth, gingiva); maximum and/or minimum number of features; mandatory, permissible, and/or forbidden locations for a feature; mandatory, permissible, and/or forbidden feature shapes (e.g., cross-sectional shape, curvature, inclination, overhang); tolerances for feature geometry (e.g., tolerances for shape, size, and/or location); support requirements for a feature; support capabilities of a feature; etc.

The appliance concept can be determined using any suitable computing system or device, such as the appliance design system 514 of FIG. 5. The appliance concept can be manually generated by operators of the appliance design system 514, automatically generated using real-time and/or automated software algorithms implemented by the appliance design system 514, or suitable combinations thereof. In some embodiments, some or all of the appliance parameters for the appliance concept are determined based on the treatment plan and/or other relevant information received from the clinician and/or treatment planning system. Alternatively or in combination, some or all of the appliance parameters can be predetermined values, rules, constraints, etc., that are retrieved from a suitable data source (e.g., a database of parameters for a particular appliance type). Optionally, some or all of the appliance parameters can be determined based on experimental data, clinical data from other patient cases, simulations, rule-based algorithms, machine learning algorithms, etc.

At block 606, the appliance concept can be used to generate a 3D digital model of the dental appliance. The 3D digital model can depict an appliance geometry that fulfills some or all of the appliance parameters associated with the appliance concept. The appliance geometry can be configured to mitigate loss of fidelity when the appliance is manufactured, as described in greater detail below. The 3D digital model can be any digital representation of the 3D shape of the appliance, such as a surface model, mesh model, non-parametric model, parametric model, etc. The 3D digital model can be provided in any suitable file format, such as a CAD file, STL file, OBJ file, AMF file, 3MF file, etc. In some embodiments, the 3D digital model is generated using a computing system or device, such as the appliance design system 514 of FIG. 5. The 3D digital model can be manually generated by operators of the appliance design system 514, automatically generated using real-time and/or automated software algorithms implemented by the appliance design system 514, or suitable combinations thereof.

At block 608, the 3D digital model can be converted into a plurality of 2D cross-sections via a slicing process. In some embodiments, the 2D cross-sections correspond to a plurality of layers for building up the dental appliance via a layer-by-layer additive manufacturing process (e.g., DLP, SLA). The characteristics of the 2D cross-sections can be based on the specific characteristics of the additive manufacturing system to be used to fabricate the dental appliance. For example, the height of the 2D cross-sections can be at least the minimum layer height of the additive manufacturing system. The direction of the 2D cross-sections relative to the overall geometry of the dental appliance can be based on the print directionality of the additive manufacturing system (e.g., the orientation of the dental appliance relative to the print directionality can be adjusted to mitigate printability issues due to applied forces during the additive manufacturing process). In some embodiments, the slicing process involves determining the locations of a plurality of slicing planes along the 3D digital model. For instance, the slicing planes can be spaced apart from each other at a plurality of different vertical locations (e.g., z-positions) along the 3D digital model. The 2D cross-sections can then be generated from the cross-sectional geometry of the 3D digital model at each slicing plane.

Additionally, the slicing process can involve converting the appliance geometry from the resolution of the 3D digital model into the print resolution of the additive manufacturing system. For example, in embodiments where the 3D digital model is a mesh or surface model, the slicing process can involve converting (e.g., rasterizing, downsampling) the model into a plurality of discrete elements to match the print unit shape and resolution used by the additive manufacturing system (e.g., DLP systems can use a plurality of square pixels, SLA systems may use a circular spot that follows contours). In some embodiments, the slicing process involves converting the appliance geometry from the coordinate system of the 3D digital model into a coordinate system that will be used by the additive manufacturing system (“print coordinate system”). In other embodiments, the 3D digital model can already be in the print coordinate system, such that no further conversion is needed during slicing.

The 2D cross-sections can be provided in any suitable file format, such as a BMP file or a PNG file. In some embodiments, the 2D cross-sections are generated using a computing system or device, such as the appliance design system 514 of FIG. 5. The 2D cross-sections can be manually generated by operators of the appliance design system 514, automatically generated using real-time and/or automated software algorithms implemented by the appliance design system 514, or suitable combinations thereof. Optionally, the slicing process can be implemented as an API call from the software used to generate the 3D digital model, such that 3D design and slicing can be performed within the same software application. In such embodiments, slicing can be performed multiple times as adjustments are made to the 3D digital model, thus providing a preview of how a particular appliance geometry will be affected by the slicing process.

At block 610, the 2D cross-sections can be assembled into a digital layout for additive manufacturing. The digital layout can be a digital representation (e.g., one or more 2D images) showing the spatial location of the dental appliance on the active print area and/or build platform of the additive manufacturing system. In some embodiments, the digital layout uses the same resolution and coordinate system as the 2D cross-sections, which can be the same resolution and coordinate system of the additive manufacturing system, as discussed above. Accordingly, the 2D cross-sections can be placed directly into the digital layout, without additional conversion processes to change the resolution and coordinate system of the 2D cross-sections.

The digital layout can also include other components besides the appliance. For example, the digital layout can include support structures that are connected to the appliance to mechanically stabilize the appliance during fabrication, such as struts, crossbars, rafts, etc. Such support structures can be removed during post-processing. Alternatively or in combination, the digital layout can include support structures that are separate from the appliance but also improve printability by controlling the peel behavior and/or other process physics associated with additive manufacturing, such as sidewalls, blocks, etc. Optionally, the digital layout can include reference structures (e.g., coupons) that are used for quality control and/or tracing purposes (e.g., checking dimensional accuracy and/or alignment, identifying the appliance). These additional components can be added at any suitable stage in the workflow 600, such as when generating the 3D digital model (block 606), 2D cross-sections (block 608), and/or digital layout (block 610).

In embodiments where the dental appliance is printed as part of a batch of multiple appliances, the digital layout can include 2D cross-sections from each of the appliances. In such embodiments, the layout process can include determining how to position each appliance on the build platform in a manner that complies with requirements for dimensional tolerances, spacing, printability, and efficiency. For example, the layout can maintain sufficient distance between neighboring appliances to avoid overlap and/or printability issues, while still packing the appliances tightly enough to efficiently use the available space on the build platform. The layout can also consider the effects of print directionality on manufacturability, such as by positioning and orienting the appliances in a manner to avoid deformation, fractures, etc., due to forces applied by the printer assembly or other component during additive manufacturing. Optionally, in embodiments where one or more light sources (e.g., projectors) are used in the additive manufacturing process, the layout can be determined at least in part on the optical characteristics of each light source. For instance, if a light source is known to have a non-uniform optical distribution so that certain pixels in the field of view are blurrier or sharper than other pixels, appliance portions that require high fidelity may be positioned at locations corresponding to sharper pixels, while appliance portions that can tolerate some loss of fidelity may be positioned at locations corresponding to blurrier pixels. Alternatively or in combination, the layout itself may be modified (e.g., digitally masked) to compensate for variations in the optical distribution of the light source(s) so that the actual printed object pixels are substantially uniform (e.g., have the same or similar degree of sharpness/blurriness). The layout can also be determined based on print priority information, as discussed further below.

The digital layout can be generated using any suitable computing system or device, such as the appliance design system 514 of FIG. 5. The digital layout can be manually generated by operators of the appliance design system 514, automatically generated using real-time and/or automated software algorithms implemented by the appliance design system 514, or suitable combinations thereof.

At block 612, the digital layout is used to generate fabrication instructions for additive manufacturing of the dental appliance(s). The fabrication instructions can be in any suitable file format, such as a toolpath file (e.g., G-code file). Optionally, the digital layout can be used directly as the fabrication instructions. The fabrication instructions can be transmitted to a fabrication system configured to additively manufacture the dental appliance(s) (e.g., the additive manufacturing system 518 of FIG. 5). Optionally, the fabrication system can also be or include a system that performs post-processing of the manufactured appliance(s) (e.g., the post-processing system 520 of FIG. 5).

In some embodiments, the fabrication system is associated with a set of manufacturing parameters (block 614). The manufacturing parameters can represent one or more capabilities, constraints, and/or conditions associated with processes and/or hardware implemented by the fabrication system (e.g., processes and/or hardware of the additive manufacturing system 518 and/or the post-processing system 520 of FIG. 5). For example, the manufacturing parameters can include any of the following a minimum feature size of the additive manufacturing system (e.g., pixel size, spot diameter), a minimum layer height of the additive manufacturing system (e g, minimum layer thickness, minimum curing depth), a print resolution of the additive manufacturing system (e.g., horizontal and/or vertical resolution), a print coordinate system of the additive manufacturing system (e.g., a coordinate grid used when depositing and/or curing material), a print unit shape of the additive manufacturing system (e.g., pixels for a DLP system, a circular spot for an SLA system), a print directionality of the additive manufacturing system (e.g., movement direction of a printer assembly, direction of minimum applied stress/force during printing, direction of maximum applied stress/force during printing), a print offset of the additive manufacturing system, a predicted amount of overcuring of the additive manufacturing system, a predicted amount of deformation (e.g., due to mechanical stresses, temperatures, solvents, and/or other conditions during additive manufacturing and/or post-processing), a predicted amount of material loss (e.g., due to solvents and/or other post-processing conditions), a predicted amount of residual material after cleaning (e.g., excess material that may be incorporated into the object after post-curing), and/or layout-specific conditions (e.g., predicted stresses/forces at different locations of the layout, different sharpness/blurriness values at different locations of the layout due to variations in the optical distribution of the light source(s)).

As indicated by the broken lines in FIG. 6, the manufacturing parameters of the fabrication system can be used as inputs to various processes of the workflow 600, such as the process of determining an appliance concept (block 604), generating a 3D digital model (block 606), generating 2D cross-sections (block 608), and/or generating a digital layout (block 610). For example, the manufacturing parameters can be used when determining the appliance concept (block 604) to adjust one or more appliance parameters to be consistent with the capabilities and/or limitations of the fabrication system. As another example, the manufacturing parameters can be used when generating the 3D digital model (block 606) to ensure that the appliance geometry is less susceptible to loss of fidelity that may occur due to the particular characteristics of the fabrication system. Stated differently, the manufacturing parameters can be used to design and/or adjust the appliance geometry to mitigate undesirable changes in size, shape, and/or location of certain appliance regions and/or features that might otherwise occur during fabrication of the dental appliance. In a further example, the manufacturing parameters can be used during the slicing process (block 608) to predict and/or select locations of one or more slicing planes that are less likely to interfere with the intended object geometry. In yet another example, the manufacturing parameters can be used during the layout process (block 610) to position and orient each appliance in a manner that improves printability and/or fidelity.

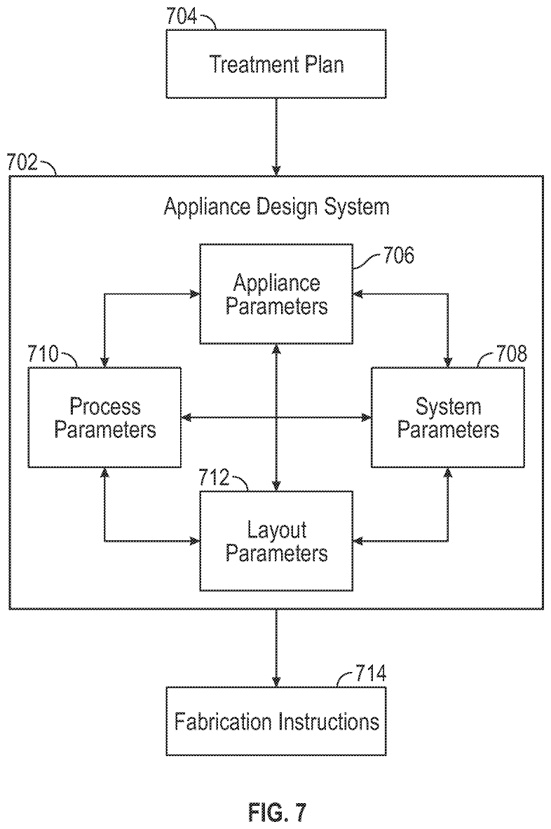

FIG. 7 is a flow diagram illustrating various types of data associated with an appliance design system 702, in accordance with embodiments of the present technology. The appliance design system 702 can be any suitable computing system or device, such as the appliance design system 514 of FIG. 5.

As shown in FIG. 7, a treatment plan 704 can be provided to the appliance design system 702. The appliance design system 702 can then determine a set of appliance parameters 706 for a dental appliance, based on the treatment plan 704. The appliance parameters 706 can be determined using software algorithms, determined based on user input, retrieved from one or more data sources, or any other suitable technique. As described herein, the appliance parameters 706 can be one or more rules, constraints, requirements, etc., defining the geometry of the dental appliance. For example, the appliance parameters 706 can include one or more of the following: maximum and/or minimum size of a feature; maximum and/or minimum spacing between neighboring features; maximum and/or minimum spacing between a feature and nearby anatomical structures; maximum and/or minimum number of features; mandatory, permissible, and/or forbidden locations for a feature; mandatory, permissible, and/or forbidden feature shapes; tolerances for a feature geometry; support requirements for a feature; and/or support capabilities of a feature.

The appliance design system 702 can also determine a set of manufacturing parameters for fabricating the dental appliance. In the illustrated embodiment, for example, the manufacturing parameters include system parameters 708, process parameters 710, and layout parameters 712. In other embodiments, any of the parameters shown in FIG. 7 can be omitted and/or the manufacturing parameters can include other parameters besides the embodiments shown in FIG. 7. The manufacturing parameters can be retrieved from a suitable data source (e.g., as a configuration file or other data structure storing presets for different types of additive manufacturing systems and/or post-processing systems), determined based on user input, or suitable combinations thereof.

The system parameters 708 can represent the hardware-specific capabilities and/or constraints of an additive manufacturing system that will be used to fabricate the dental appliance. For example, the system parameters 708 can include information regarding the minimum feature size, minimum layer height, print resolution, print coordinate system, print unit shape, print directionality, print offset, and/or overcuring of the additive manufacturing system. In embodiments where the dental appliance is to be fabricated using a hybrid additive manufacturing technique that uses two or more additive manufacturing systems, the system parameters 708 can include information for each of the additive manufacturing systems.

The process parameters 710 can represent conditions associated with one or more post-processing operations to be used when fabricating the dental appliance. As described herein, such post-processing operations can include removing residual material from the appliance after additive manufacturing (e.g., uncured resin), post-curing the appliance, annealing the appliance, washing, removing support structures, surface modifications, etc. The process parameters 710 can include information regarding deformation of the appliance that may occur due to mechanical stresses, temperatures, solvents, and/or other post-processing conditions. The process parameters 710 can also indicate an amount of material loss that may occur, e.g., due to solvents and/or other post-processing conditions. The process parameters 710 can also indicate material artifacts that may become incorporated into the appliance, e.g., due to the presence of residual excess material during post-curing.

The layout parameters 712 can represent conditions associated with the position and/or orientation of the dental appliance on the layout. For instance, appliances at different positions on the layout (e.g., different quadrants, arches, segments) can experience different mechanical stresses during additive manufacturing, e.g., due to their geometry and/or the directionality of the additive manufacturing system. Additionally, the printability of the appliance can be affected by the orientation of the appliance on the layout, as well as the spacing between the appliance and other objects on the layout (e.g., other appliances, support structures, reference structures). Moreover, the sharpness/blurriness of pixels at different locations on the layout may vary, e.g., depending on the optical distribution of the light source(s) of the additive manufacturing system.

The appliance design system 702 can determine an appliance geometry for the dental appliance based on the appliance parameters 706, system parameters 708, process parameters 710, and/or layout parameters 712. For example, in some embodiments, the appliance design system 702 uses an iterative approach in which an initial appliance geometry is generated based on the appliance parameters 706. For instance, the appliance parameters 706 can be used to determine a set of appliance design rules, which in turn can be used to determine the initial appliance geometry. The initial appliance geometry can then be evaluated to determine whether loss of fidelity is likely to occur during manufacturing due to the capabilities, constraints, conditions, etc., represented by the system parameters 708, process parameters 710, and/or layout parameters 712. If the appliance design system 702 determines that loss of fidelity is likely to occur (e.g., the deviation in appliance size, shape, and/or location exceeds a tolerance value), the appliance design system 702 can adjust the initial appliance geometry to mitigate the loss of fidelity. The adjustments can include changing the shape, size, position, and/or orientation of one or more appliance features, as described in greater detail below. The adjusted appliance geometry can then be reevaluated for loss of fidelity issues. This process can be iteratively repeated until a final appliance geometry that reduces (e.g., minimizes) loss of fidelity is determined. Optionally, the order in which the parameters are considered during the appliance design process can vary, as indicated by the double-headed arrows shown in FIG. 7.

As another example, the appliance design system 702 can use an optimization approach in which the appliance parameters 706 define a solution space for the appliance geometry, and the system parameters 708, process parameters 710, and/or layout parameters 712 impose constraints on the solution space. In such embodiments, the appliance design system 702 can implement an optimization algorithm that solves for an appliance geometry that satisfies as many of the appliance parameters 706, system parameters 708, process parameters 710, and/or layout parameters 712 as possible. Optionally, different parameters can be assigned different priorities (e.g., different weights) in the optimization algorithm depending on considerations such as clinical efficacy and/or printability.

The output of the appliance design system 702 can be a set of fabrication instructions 714 for manufacturing the dental appliance with the determined appliance geometry. The fabrication instructions 714 can be or include a 3D digital model of the appliance, a plurality of 2D cross-sections generated by slicing the 3D digital model, a digital layout with the 2D cross-sections, or any other suitable digital input to the additive manufacturing system, as described herein.

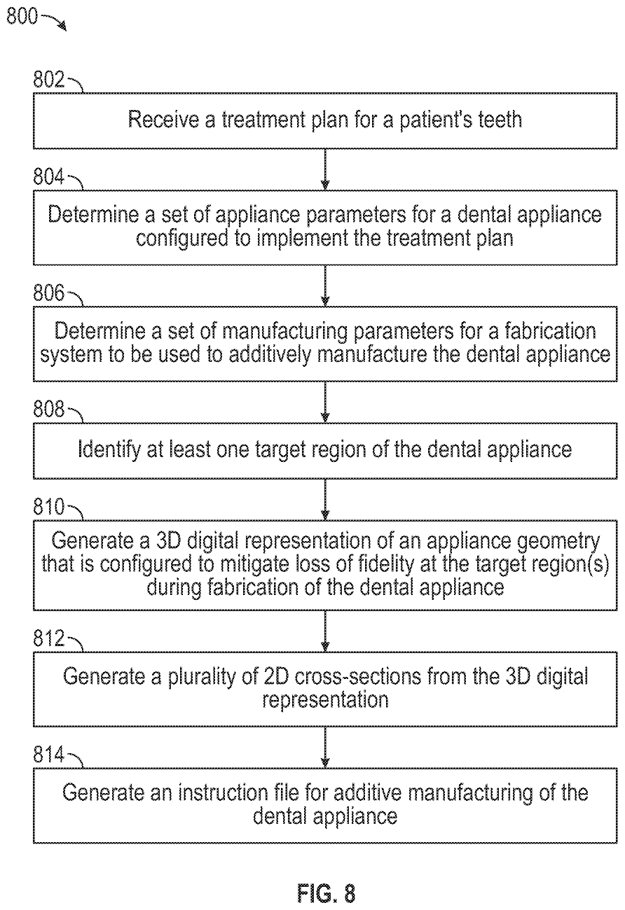

FIG. 8 is a flow diagram illustrating a method 800 for designing a dental appliance, in accordance with embodiments of the present technology. The method 800 can be performed using any suitable system or device (e.g., the appliance design system 514 of FIG. 5, the appliance design system 702 of FIG. 7). In some embodiments, some or all of the processes of the method 800 are implemented as computer-readable instructions (e.g., program code) that are configured to be executed by one or more processors of a computing device.

The method 800 can begin at block 802 with receiving a treatment plan for a patient's teeth. The treatment plan can include a target arrangement for the teeth and a plurality of treatment stages configured to reposition the teeth from an initial arrangement toward the target arrangement, as described herein.

At block 804, the method 800 can include determining a set of appliance parameters for a dental appliance configured to implement at least one treatment stage of the treatment plan. The dental appliance can be any of the appliance types provided herein, such as an aligner, palatal expander, retainer, attachment placement device, oral sleep apnea appliance, mouth guard, etc. As described herein, the appliance parameters can be one or more rules, constraints, and/or requirements defining the geometry of the dental appliance such as any of the following: one or more of the following: maximum and/or minimum size of a feature; maximum and/or minimum spacing between neighboring features; maximum and/or minimum spacing between a feature and nearby anatomical structures; maximum and/or minimum number of features; mandatory, permissible, and/or forbidden locations for a feature; mandatory, permissible, and/or forbidden feature shapes; tolerances for feature geometry; support requirements for a feature; and/or support capabilities of a feature.

At block 806, the method 800 can include determining a set of manufacturing parameters for a fabrication system to be used to additively manufacture the dental appliance. As described herein, the manufacturing parameters can represent one or more capabilities, constraints, and/or conditions corresponding to the fabrication system (e.g., additive manufacturing system and/or post-processing system). For example, the manufacturing parameters can include any of the following minimum feature size, minimum layer height, print resolution, print coordinate system, print unit shape, print directionality, print offset, predicted amount of overcuring, predicted amount of deformation, predicted amount of material loss, predicted amount of residual material after cleaning, and/or layout-specific conditions. In some embodiments, the manufacturing parameters include system parameters, process parameters, and/or layout parameters, as described in connection with FIG. 7.

At block 808, the method 800 can include identifying at least one target region of the dental appliance, based on the appliance parameters. Each target region can be a portion of the dental appliance that is important to the proper function of the appliance, such as clinical efficacy, positioning, ergonomics, mechanical properties, aesthetics, safety, etc. For example, the target region can be a portion of the appliance that applies one or more forces to reposition one or more teeth, such as the inner surface of a tooth-receiving cavity, an attachment receptacle, an attachment, a contact point, a pressure point, a power ridge, etc. As another example, the target region can be a portion of the appliance that ensures proper positioning of an appliance feature, such as supports and/or other features in an attachment placement device that position an attachment at a desired location on a tooth. In yet another example, the target region can be a portion of the appliance that contributes to proper appliance fit on the teeth, such as the inner surface of a tooth-receiving cavity, cutlines, interproximal regions, etc.

The target region(s) can be identified in many different ways, such as using one or more rules (e.g., heuristic rules), user input, machine learning algorithms, simulations, experimental data, clinical data from other patient cases, or suitable combinations thereof. In some embodiments, the process of block 810 involves labeling each location of the dental appliance (e.g., each voxel, facet, vertex, etc., of a 3D model of the appliance) with an identifier indicating the relative importance of that location.

At block 810, the method 800 can continue with generating a 3D digital representation of an appliance geometry that is configured to mitigate loss of fidelity at the target region(s) during fabrication, thereby enhancing functional performance of the appliance. The appliance geometry can be designed based at least in part on the appliance parameters determined in block 806, e.g., to ensure that the appliance fulfills some or all of the clinical goals of the corresponding stage of the treatment plan. For example, the appliance parameters can be used to identify and/or generate a set of appliance design rules, and the appliance geometry can be designed to comply with at least some or all of the appliance design rules. Optionally, different rules can be weighted differently or otherwise prioritized over other rules, e.g., based on considerations such as clinical efficacy, proper positioning, ergonomics, printability, material consumption, etc.

In some embodiments, the appliance geometry is designed based at least in part on the manufacturing parameters determined in block 806, e.g., to avoid or mitigate undesirable changes in size, shape, and/or location of the target region(s) that might otherwise occur during fabrication of the appliance. For example, the geometry of the target region(s) can be designed to avoid or mitigate loss of fidelity that may occur when converting the appliance geometry into the print resolution of the fabrication system. This can be accomplished by prioritizing the target region(s) to be properly arranged in the printer coordinate system, positioning target region(s) proximate to auxiliary support structures, and/or tuning of alternative print dimension parameters (e.g. smaller layer thickness in the vertical dimension if the pixel size in the horizontal dimension is too coarse). Other regions can be designed, oriented, and/or arranged such that the features and structures are greater than or equal to the print resolution (e.g., at least 2×, 3×, 4×, or 5× greater than the print resolution). Alternatively or in combination, the shape of the target region(s) can be designed so that any loss of shape fidelity due to changes in resolution are not expected to affect the function of the target region(s) in a manner that compromises clinical efficacy, fit on the teeth, mechanical properties, printability, etc.

As another example, the geometry of the target region(s) can be designed to avoid or mitigate loss of fidelity that may occur when converting the appliance geometry into the print coordinate system of the fabrication system. This can be accomplished by adjusting the positions of the features of the target region(s) to be aligned with the grid defined by the print coordinate system (e.g., “snap to grid” functionality), such that the intended shape of the features is preserved in the print coordinate system, or such that any loss of shape fidelity due to misalignment with the print coordinate system is not expected to significantly affect the function of the target region(s).

In a further example, the geometry of the target region(s) can be designed to avoid or mitigate loss of fidelity that may occur due to behavior of the additive manufacturing system and/or process conditions, such as overbuild, overcure, deformation, loss of material during post-processing, incorporation of excess material, etc. In some embodiments, the shape of the target region(s) is adjusted to compensate for deviations during additive manufacturing and/or post-processing, such as by offsetting the inner and/or outer surfaces of the target region(s), scaling the features of the target region(s), and/or selectively adding and/or removing pixels to the target region(s). Optionally, shape changes due to deformation can be modeled, and used to determine a transformation that can be applied to the target region(s) to reverse or otherwise compensate for the deformation.

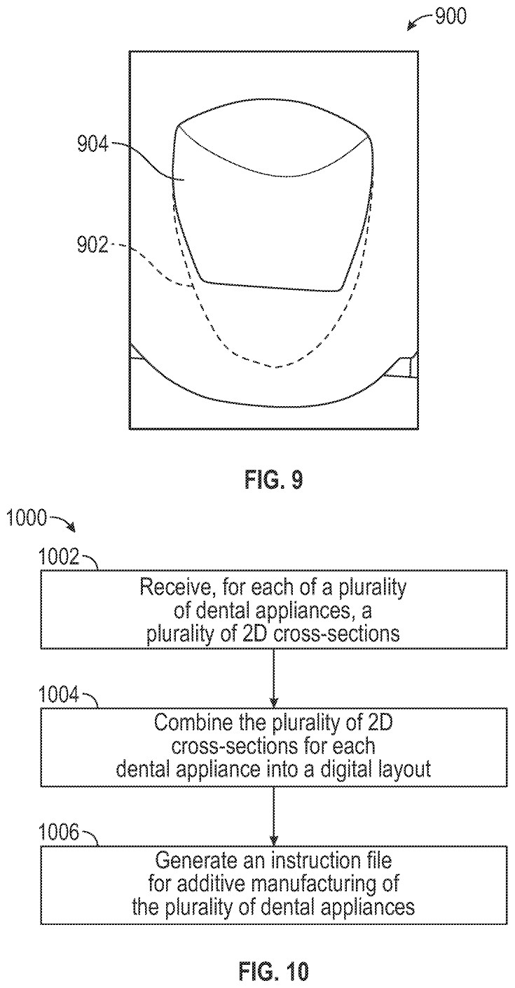

For instance, FIG. 9 illustrates a design for a target region 900 of an additively manufactured object (e.g., a prefabricated attachment) that compensates for overcuring, in accordance with embodiments of the present technology. In FIG. 9, the broken lines indicate the intended shape 902 of the target region 900, while the solid lines indicate the designed shape 904 of the target region 900. During additive manufacturing, overcuring may cause the actual extent of the cured material to exceed the boundaries of the designed shape 904. Accordingly, the designed shape 904 can be smaller than the intended shape 902, such that when overcuring occurs, the actual shape of the target region 900 is the same or similar to the intended shape 902.

Referring again to block 810 of FIG. 8, in yet another example, the geometry of the target region(s) can be designed to avoid or mitigate loss of fidelity due to locations of the slicing planes. In some embodiments, the locations of one or more slicing planes can affect the actual printed shape of the object, particularly for convex and/or concave surfaces. Accordingly, the process of block 810 can be involve determining the locations of some or all of the slicing planes, evaluating the effect of the locations of the slicing planes on the shape of the target region(s), then adjusting the z-position of the features of the target region(s) as appropriate to reduce or prevent loss of shape fidelity.

As a further example, the geometry of the target region(s) can be designed to avoid or mitigate loss of fidelity that may occur due to printability issues. This can be accomplished by identifying features within the target region(s) that are likely to require supports for printability (e.g., features having significant amounts of overhang and/or inclination), and determining the parameters of the supports to be printed together with those features (e.g., support capability, support radius). Alternatively or in combination, the orientation and/or inclination of features within the target region(s) can be adjusted to improve printability, based on the printer directionality and/or other relevant manufacturing parameters. For instance, the process of block 810 can involve predicting the effects of different orientations and/or inclinations on printability (e.g., using finite element modeling or physics-based simulations), then selecting the orientation and/or inclination that produces optimal or improved printability. Optionally, the orientation of the entire appliance is adjusted to improve printability of the target region(s). In some embodiments, the process of block 812 involves predicting the effects of layout location on printability, and generating instructions for the downstream layout software to adjust the layout of the particular appliance to improve printability (e.g., assigning the appliance to a particular location in the layout, indicating that support structures should be added to the appliance or to the build platform proximate to the appliance).

In some embodiments, the process of block 810 involves generating an initial geometry for the appliance (e.g., based on the appliance parameters of block 804), then evaluating whether the target region(s) of the appliance are likely to experience loss of fidelity due to the manufacturing parameters of the fabrication system. The evaluation can be performed based on simulation data (e.g., finite element simulations, physics-based simulations), experimental data, rule-based algorithms, machine learning algorithms, and/or any other suitable technique. For instance, the evaluation can involve predicting an actual geometry of the target region(s) after additive manufacturing and/or post-processing, then comparing the actual geometry to the intended geometry to predict loss of fidelity. If the predicted loss of fidelity exceeds the permissible tolerance value or is otherwise expected to significantly affect the function of the appliance, the initial geometry can be adjusted to prevent, reduce, or otherwise mitigate the loss of fidelity, such as by changing the position of an appliance feature, changing the shape of an appliance feature, changing the inclination of an appliance feature, changing the orientation of an appliance feature, changing the orientation of the appliance, adding a support structure, and/or any of the other techniques described herein. The adjusted geometry can then be reevaluated for loss of fidelity, and further adjustments can be made if appropriate. This process can be iterated until an optimized appliance geometry is determined.

In some embodiments, the process of block 810 is implemented by appliance design software including a user interface allowing a user (e.g., a technician, clinician, or other operator) to view, provide feedback on, and/or otherwise interact with the 3D digital representation of the appliance geometry. Optionally, the user interface can show digital representations of the intended appliance geometry versus the predicted appliance geometry after additive manufacturing and/or post-processing, so the user can visually assess the regions of the appliance that are likely to experience loss of fidelity. Moreover, the user interface can generate and display error messages and/or visual indicators alerting the user to appliance regions that are predicted to experience loss of fidelity and/or printability issues. Subsequently, the user can manually adjust the affected regions, or can instruct the appliance design software to adjust and/or replace the affected regions. In other embodiments, the appliance design software can automatically adjust and/or replace the affected regions without requiring user input.

At block 812, the method 800 can continue with generating a plurality of 2D cross-sections from the 3D digital representation. As described herein, the 2D cross-sections can be slices corresponding to a plurality of layers for building up the dental appliance via a layer-by-layer additive manufacturing process. The 2D cross-sections can be generated based on the specific characteristics of the additive manufacturing process. For example, the height of the 2D cross-sections can be at least the minimum layer height of the fabrication system. The direction of the 2D cross-sections relative to the overall geometry of the dental appliance can be based on the print directionality of the additive manufacturing system. Additionally, the process of block 812 can involve converting (e.g., downsampling and/or rasterizing) the appliance geometry into a different resolution and coordinate system, such as the print resolution and print coordinate system. As discussed above, the appliance geometry can already be designed to properly align with the print coordinate system, in order to reduce loss of fidelity when converting into the print resolution and print coordinate system. In some embodiments, the 3D digital representation is provided in a first file format (e.g., a 3D modeling format such as a CAD file, STL file, OBJ file, AMF file, 3MF file, etc.) and the 2D cross-sections are in a second, different file format (e.g., a 2D image format such as a BMP file, PNG file, etc.). Accordingly, the process of block 812 can involve converting the appliance geometry from the first file format into the second file format.

In some embodiments, the method 800 involves generating the plurality of 2D cross-sections, then evaluating whether there is any unacceptable loss of fidelity in the portions of the 2D cross-sections corresponding to the target region(s). The evaluation can be performed automatically by the software (e.g., using simulations, rule-based algorithms, machine learning algorithms), manually by the user (e.g., by viewing and interacting with the 2D cross-sections displayed on a user interface), or suitable combinations thereof. If an unacceptable loss of fidelity is identified, the appliance geometry and/or locations of one or more slicing planes can be adjusted to mitigate the loss of fidelity, and the slicing process can be repeated to generate and evaluate a new plurality of 2D cross-sections. To facilitate this iterative approach, the slicing process of block 812 can be implemented as an API call (or similar functionality) from the appliance design software used to generate the 3D digital representation of block 810, or can be implemented using the same software.

At block 814, the method 800 can generate an instruction file for additive manufacturing of the dental appliance. The instruction file can be a digital layout including the 2D cross-sections of block 812, or can be a separate file (e.g., a toolpath file) generated based on the digital layout, as described elsewhere herein. In embodiments where the appliance is fabricated from a curable precursor material (e.g., a polymeric resin), the instruction file can indicate the locations (e.g., pixel coordinates) where the material should or should not be cured, as well as the curing parameters associated with that location, such as intensity, exposure time, wavelength, grayscaling, etc. The information included in the instruction file can vary according to the type of additive manufacturing process used (e.g., SLA versus DLP) and/or the specific configuration of the additive manufacturing system.

In some embodiments, the process of block 814 involves generating a digital layout showing the location and/or orientation of the dental appliance (e.g., of the 2D cross-sections of the appliance) on the active print area and/or build platform of the additive manufacturing system. The digital layout can use the same resolution and coordinate system as the 2D cross-sections, which can be the same as the print resolution and print coordinate system, respectively. Accordingly, in such embodiments, the 2D cross-sections can be placed directly into the digital layout, without additional conversion processes to change the resolution and coordinate system of the 2D cross-sections. In other embodiments, however, some or all of the 2D cross-sections can be in a different resolution and/or coordinate system, and can be converted into the resolution and/or coordinate system of the digital layout.

The position and/or orientation of the appliance in the digital layout can be determined in various ways. In some embodiments, the position and/or orientation is determined based at least in part on the manufacturing parameters of block 806. For instance, the position and/or orientation of the appliance may affect the fidelity of the target region due to printability considerations (e.g., directionality of the additive manufacturing system). Accordingly, the process of block 814 can include determining a position and/or orientation for the dental appliance to avoid loss of fidelity during additive manufacturing. In some embodiments, this process involves predicting the effects of different positions and/or orientations on printability (e.g., using finite element modeling or physics-based simulations), then selecting the position and/or orientation that produces optimal or improved printability. In other embodiments, the position and/or orientation can be already have been determined (e.g., during the process of block 810), in which case the process of block 814 can simply involve placing the 2D cross-sections in the layout according to the previously determined position and/or orientation.

Optionally, the process of block 814 can also involve adding one or more additional components to the digital layout. For instance, in embodiments where the dental appliance is printed as part of a batch of multiple appliances, the process of block 814 can involve combining the 2D cross-sections from each appliance into a single digital layout. A representative example of a method for generating a digital layout for a plurality of dental appliances is described below in connection with FIG. 10. Alternatively or in combination, the process of block 814 can involve adding other types of components to the digital layout, such as support structures (e.g., struts, crossbars, rafts, sidewalls, blocks), reference structure (e.g., coupons), etc.

In some embodiments, the layout process of block 814 is implemented by digital layout software including a user interface allowing a user (e.g., a technician, clinician, or other operator) to view, provide feedback on, and/or otherwise interact with the digital layout. Optionally, the process of block 814 can be implemented as an API call (or similar functionality) from the appliance design software used to generate the 3D digital representation of block 810, or can be implemented using the same software.

The method 800 of FIG. 8 can be modified in many ways. For example, although the method 800 is described above in terms of mitigating loss of fidelity at one or more target regions of a dental appliance, the method 800 can alternatively be used to mitigate loss of fidelity for the entire appliance geometry. In such embodiments, the fidelity of the target region(s) can be prioritized over the fidelity of other regions of the appliance when designing the appliance geometry. Optionally, the fidelity requirements for the target region(s) can be higher than the fidelity requirements for other appliance regions, e.g., there may be stricter manufacturing tolerances for the target region(s) compared to other appliance regions. In other embodiments, however, all appliance regions can be prioritized equally and/or have the same fidelity requirements, and the process of block 808 can be omitted.

As another example, in embodiments where the dental appliance is to be fabricated using two different additive manufacturing processes (e.g., DLP or SLA process combined with a jetting process), the method 800 can be modified to accommodate the different capabilities, constraints, and/or conditions associated with each additive manufacturing process. In such embodiments, the method 800 can include determining a set of manufacturing parameters for each additive manufacturing process, such as a set of first manufacturing parameters for a first additive manufacturing process, a set of second manufacturing parameters for a second additive manufacturing process, etc. The method 800 can also include identifying the region(s) of the appliance to be fabricated using each additive manufacturing process, such as one or more first target regions to be fabricated using the first additive manufacturing process, one or more second target regions to be fabricated using the second additive manufacturing process, etc. Subsequently, the method 800 can generate an appliance geometry that mitigates loss of fidelity at the respective appliance region(s) based on the corresponding set of manufacturing parameters, such as by using the first manufacturing parameters to determine and/or adjust the geometry for the first target region(s), using the second manufacturing parameters to determine and/or adjust the geometry for the second target region(s), etc. This approach allows the appliance design process to be customized on a per region basis to accommodate different fabrication processes, different materials, and/or other considerations relevant to hybrid additive manufacturing.

FIG. 10 is a flow diagram illustrating a method 1000 for fabricating a plurality of dental appliances, in accordance with embodiments of the present technology. The method 1000 can be performed using any suitable system or device (e.g., the appliance design system 514 of FIG. 5, the appliance design system 702 of FIG. 7). In some embodiments, some or all of the processes of the method 1000 are implemented as computer-readable instructions (e.g., program code) that are configured to be executed by one or more processors of a computing device.

The method 1000 can begin at block 1002 with receiving, for each of a plurality of dental appliances, a plurality of 2D cross-sections. The plurality of dental appliances can include any suitable number of appliances that are intended to be fabricated together in a single batch (e.g., in the same additive manufacturing operation), such as two, three, four, five, 10, 20, 30, 40, 50, or more serialized or unique appliances. The dental appliances can be any of the appliance types described herein, such as aligners, palatal expanders, retainers, attachment placement devices, oral sleep apnea appliances, mouth guards, etc. Some or all of the plurality of dental appliances can be configured to implement different stages of a treatment plan for a patient's teeth. Some or all of the appliances can be used to treat the same patient, or some or all of the appliances can be used to treat different patients.

Each dental appliance can be associated with a respective plurality of 2D cross-sections. The 2D cross-sections can be slices corresponding to a plurality of layers for building up the corresponding dental appliance via a layer-by-layer additive manufacturing process, as described herein. The 2D cross-sections can be generated in any suitable manner (e.g., in accordance with the method 800 of FIG. 8) and can be provided in any suitable file format (e.g., BMP files, PNG files, or other 2D image file formats). In some embodiments, for example, the 2D cross-sections depict an appliance geometry that has been designed to mitigate loss of fidelity due to manufacturing parameters, as discussed elsewhere herein.

At block 1004, the method 1000 can include combining the plurality of 2D cross-sections for each dental appliance into a digital layout. The digital layout can show the position and orientation of each dental appliance on the build platform of the additive manufacturing system. In some embodiments, the digital layout uses the same resolution and coordinate system as the 2D cross-sections, which can be the same as the print resolution and print coordinate system, respectively. Accordingly, the 2D cross-sections for each dental appliance can be placed directly into the digital layout, without additional conversion processes to change the resolution and coordinate system of the 2D cross-sections. In other embodiments, however, some or all of the 2D cross-sections can be in a different resolution and/or coordinate system, and can be converted into the resolution and/or coordinate system of the digital layout.

The process of block 1004 can include determining how to position and orient each appliance on the build platform in a manner that complies with requirements for spacing, printability, and/or efficiency. For example, the layout can maintain sufficient distance between neighboring appliances to avoid overlap and/or potential printing issues, while still packing the appliances tightly enough to efficiently use the available space on the build platform. Additionally, each appliance can be positioned and/or oriented in a manner that reduces the likelihood of loss of fidelity and/or print failure due to applied forces during additive manufacturing. For instance, components that are angled can be oriented in a direction different from (e.g., opposite of) the direction of applied forces to improve fidelity (e.g., as shown in FIG. 4F). As another example, appliances that are more fragile can be placed at locations that experience lower forces during additive manufacturing, while appliances that are more durable can be placed at locations that experience higher forces during additive manufacturing.

In some embodiments, the process of block 1004 involves predicting the effects of different positions and/or orientations on printability of each appliance, such as by using finite element modeling, physics-based simulations, rule-based algorithms, machine learning algorithms, experimental data, etc. Based on the prediction, a position and/or orientation that produces optimal or improved printability can be selected for each appliance. In other embodiments, however, the position and/or orientation of each appliance may have been previously determined (e.g., during the appliance design process of FIG. 8), in which case the process of block 1004 can simply involve placing the 2D cross-sections in the layout according to the previously determined position and/or orientation.

Optionally, some or all of the 2D cross-sections can be labeled or otherwise associated with information that can be used to determine the appropriate placement of the corresponding dental appliance in the digital layout. For example, the 2D cross-sections for some or all of the appliances can be labeled with or otherwise associated with layout instructions, such as required, preferred, permitted, and/or forbidden locations; required, preferred, permitted, and/or forbidden orientations, etc. As another example, the 2D cross-sections can include an identifier indicating the particular dental appliance to which the 2D cross-section belongs, thus allowing for traceability and/or appliance-specific adjustments. In some embodiments, the identifier is used to ensure that appliances that are part of the same treatment plan (e.g., used to treat a single patient) are fabricated in the same batch. Additionally, if it is subsequently determined that modifications need to be made to a specific appliance within a batch, the portion(s) of the digital layout corresponding to that appliance can be selectively modified without affecting any of the other appliances in the layout and/or without requiring that the entire digital layout be recreated.

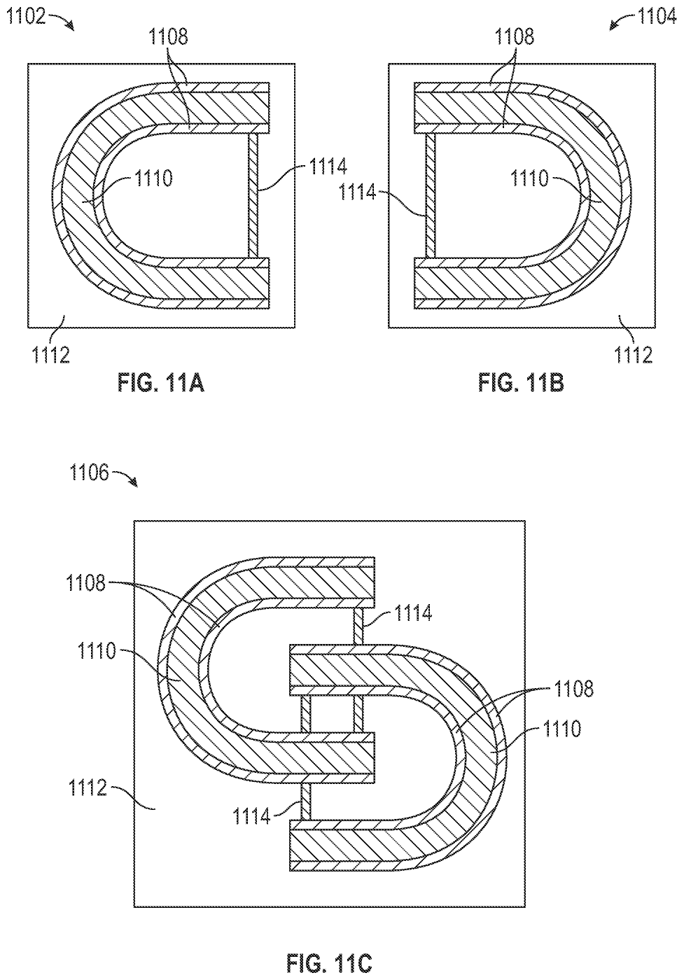

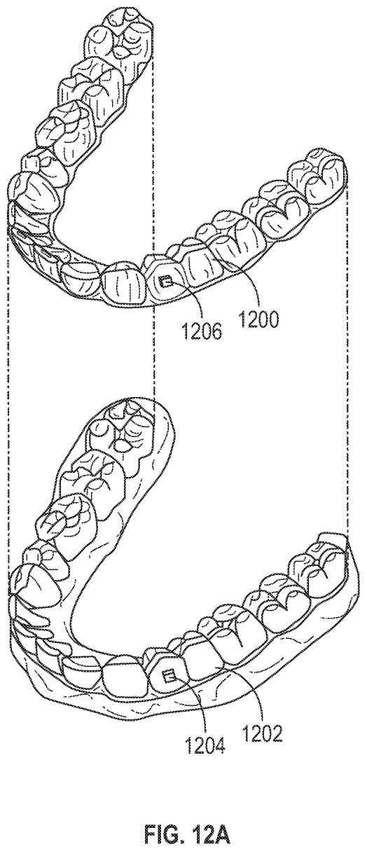

In some embodiments, the position and/or orientation of each appliance within the layout is determined based in part on print priority information, as shown in FIGS. 11A-11C. Specifically, FIG. 11A is a partially schematic illustration of a 2D cross-section 1102 of a first dental appliance, FIG. 11B is a partially schematic illustration of a 2D cross-section 1104 of a second dental appliance, and FIG. 11C is a partially schematic illustration of a digital layout 1106 that combines the 2D cross-section 1102 and the 2D cross-section 1104, in accordance with embodiments of the present technology.

Referring first to FIGS. 11A and 11B together, some or all of the locations (e.g., pixels) in the respective 2D cross-sections 1102, 1104 of the first and second dental appliances are labeled with a print priority identifier. In the illustrated embodiment, for example, each cross-section includes one or more first regions 1108 that are labeled with first print priority identifiers indicating that these locations that must be printed (e.g., material must always be deposited and/or cured at those locations). For instance, the first regions 1108 can correspond to portions of the respective dental appliances (e.g., parts of the appliance shell) and/or to other structures that are necessary during manufacturing (e.g., struts for mechanical support). The cross-sections can also include one or more second regions 1110 that are labeled with second print priority identifiers indicating that these locations must not be printed (e.g., no material can be deposited or cured at those locations). The second regions 1110 can correspond to spaces within the respective dental appliances (e.g., the empty spaces within the tooth-receiving cavities of the appliance shell). The cross-sections can also include one or more third regions 1112 are labeled with third print priority identifiers indicating that these are locations that are optional not to print (e.g., by default no material is deposited and/or cured at those locations, but it is permissible to include such material at those locations). For example, the third regions 1112 can correspond to the empty space around the appliance. The cross-sections can also include one or more fourth regions 1114 are labeled with fourth print priority identifiers indicating that these are locations that are optional to print (e.g., by default material is deposited and/or cured at those locations, but it is permissible to omit the material at those locations). The fourth regions 1114 can correspond to structures that are helpful but not necessary for manufacturing (e.g., optional support structures, reference structures).

Alternatively or in combination, other types of print priority identifiers can be used, such as identifiers indicating that a location is to be printed only if all other locations associated with the same part are also printed, identifiers indicating that a location is printed regardless of whether other locations associated with the same part are also printed, identifiers indicating that a particular part of an appliance may intersect with another part from another appliance, identifiers indicating that a particular part of an appliance may not intersect with any other parts, etc.

Referring next to FIG. 11C, the digital layout 1106 can be determined based at least in part on the print priority identifiers included in the 2D cross-sections 1102, 1104. For instance, the digital layout 1106 can be determined using a software algorithm, such as a rule-based algorithm, a machine learning algorithm, or suitable combinations thereof. In some embodiments, the algorithm can determine a position and orientation for each appliance that (1) meets constraints for spacing, packing density, and/or printability, and (2) complies with some or all of the print priority identifiers at some or all of the locations of each appliance. The algorithm can execute logical operations based on the print priority identifiers to calculate a digital layout that satisfies as many of the constraints and print priority identifiers. Optionally, different locations, identifiers, and/or appliances can be assigned different weights, e.g., “must print” or “must not print” identifiers are prioritized over “optional to print” or “optional not to print” identifiers; certain locations within an appliance are prioritized over other locations; certain types of appliances are prioritized over other types of appliances; etc.

In the illustrated embodiment, for example, the 2D cross-sections 1102, 1104 of the first and second dental appliances are nested with each other in the digital layout 1106. Specifically, the first regions 1108 and second regions 1110 of the 2D cross-sections 1102, 1104 do not overlap each other because these regions were marked as “must print” and “must not print,” respectively. The third regions 1112 of the 2D cross-sections 1102, 1104 overlap each other because these regions were marked as optional not to print, and thus it is permissible for portions of the other appliance to extend into the third regions 1112. The fourth regions 1114 of the 2D cross-sections 1102, 1104 also overlap each other because these regions were marked as optional to print, and thus can be omitted in favor of tighter packing density.

Referring again to FIG. 10, the process of block 1004 can optionally include adding other components to the digital layout. For example, one or more support structures (e.g., struts, crossbars, rafts) can be added to some or all of the appliances to mechanically stabilize the appliance during fabrication. Additionally, one or more support structures (e.g., sidewalls, blocks) can be added to the layout to improve printability by controlling the peel behavior and/or other process physics associated with additive manufacturing. Optionally, one or more reference structures (e.g., coupons) can be added to the layout for quality control and/or tracing purposes (e.g., checking dimensional accuracy and/or alignment, identifying the appliances on the layout).

At block 1006, the method 1000 can include generating an instruction file for additive manufacturing of the plurality of dental appliances. The instruction file can be the digital layout itself, or can be a separate file generated based on the digital layout (e.g., a toolpath file), as described herein. In embodiments where the appliances are fabricated from a curable precursor material (e.g., a polymeric resin), the instruction file can indicate the locations (e.g., pixel coordinates) where the material should or should not be cured, as well as the curing parameters associated with that location, such as intensity, exposure time, wavelength, grayscaling, etc. The information included in the instruction file can vary according to the type of additive manufacturing process used (e.g., SLA versus DLP) and/or the specific configuration of the additive manufacturing system.

The method 1000 of FIG. 10 can be modified in many ways. For instance, the method 1000 can further include displaying the digital layout to a user via a user interface. The user interface can allow the user to view, modify, provide feedback on, and/or otherwise interact with the digital layout. In some embodiments, if the user determines that the digital layout is unsatisfactory (e.g., likely to lead to loss of fidelity and/or printability issues), the user can manually revise the layout, instruct the layout software to revise the layout, send feedback to the slicing software to adjust the slicing of a particular appliance, send feedback to the appliance design software to adjust the appliance geometry of a particular appliance, and/or any other suitable corrective action.

### III. Dental Appliances and Associated Methods

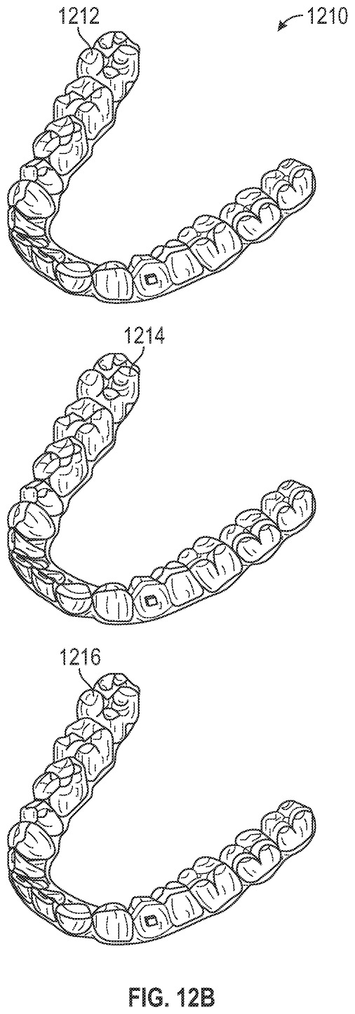

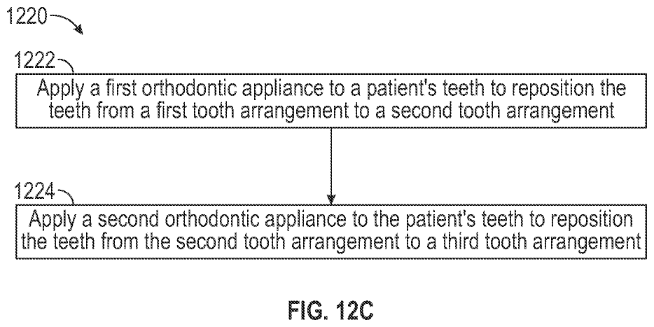

FIG. 12A illustrates a representative example of a tooth repositioning appliance 1200 configured in accordance with embodiments of the present technology. The appliance 1200 can be manufactured using any of the systems, methods, and devices described herein. The appliance 1200 (also referred to herein as an “aligner”) can be worn by a patient in order to achieve an incremental repositioning of individual teeth 1202 in the jaw. The appliance 1200 can include a shell (e.g., a continuous polymeric shell or a segmented shell) having teeth-receiving cavities that receive and resiliently reposition the teeth. The appliance 1200 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 1200 can fit over all teeth present in an upper or lower jaw, or less than all of the teeth. The appliance 1200 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 1200 can be a generic appliance configured to receive the teeth, but not necessarily shaped to match the topography of the patient's teeth. In some cases, only certain teeth received by the appliance 1200 are repositioned by the appliance 1200 while other teeth can provide a base or anchor region for holding the appliance 1200 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 1200 in place over the teeth. In some cases, however, it may be desirable or necessary to provide individual attachments 1204 or other anchoring elements on teeth 1202 with corresponding receptacles 1206 or apertures in the appliance 1200 so that the appliance 1200 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 12B illustrates a tooth repositioning system 1210 including a plurality of appliances 1212, 1214, 1216, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1210 can include a first appliance 1212 corresponding to an initial tooth arrangement, one or more intermediate appliances 1214 corresponding to one or more intermediate arrangements, and a final appliance 1216 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 12C illustrates a method 1220 of orthodontic treatment using a plurality of appliances, in accordance with embodiments of the present technology. The method 1220 can be practiced using any of the appliances or appliance sets described herein. In block 1222, a first orthodontic appliance is applied to a patient's teeth in order to reposition the teeth from a first tooth arrangement to a second tooth arrangement. In block 1224, a second orthodontic appliance is applied to the patient's teeth in order to reposition the teeth from the second tooth arrangement to a third tooth arrangement. The method 1220 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

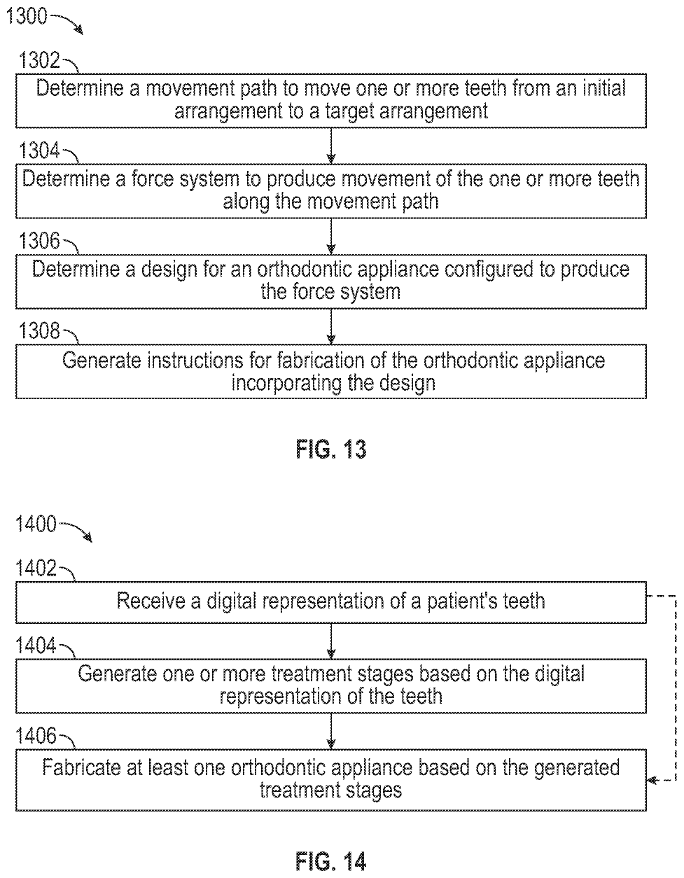

FIG. 13 illustrates a method 1300 for designing an orthodontic appliance, in accordance with embodiments of the present technology. The method 1300 can be applied to any embodiment of the orthodontic appliances described herein. Some or all of the steps of the method 1300 can be performed by any suitable data processing system or device, e.g., one or more processors configured with suitable instructions.

In block 1302, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1304, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1304 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1306, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1308, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1300 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1300 may be performed with any suitable fabrication system or device, such as the embodiments described herein. Some of the steps may be optional, e.g., the process of block 1304 can be omitted, such that the orthodontic appliance is designed based on the desired tooth movements and/or determined tooth movement path, rather than based on a force system. Moreover, the order of the steps can be varied as desired.

FIG. 14 illustrates a method 1400 for digitally planning an orthodontic treatment and/or design or fabrication of an appliance, in accordance with embodiments. The method 1400 can be applied to any of the treatment procedures described herein and can be performed by any suitable data processing system.

In block 1402 a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1404, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1406, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 14, design and/or fabrication of an orthodontic appliance, and perhaps a particular orthodontic treatment, may include use of a representation of the patient's teeth (e.g., including receiving a digital representation of the patient's teeth (block 1402)), followed by design and/or fabrication of an orthodontic appliance based on a representation of the patient's teeth in the arrangement represented by the received representation.

As noted herein, the techniques described herein can be used for the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used to manufacture attachment placement devices, e.g., appliances used to position prefabricated attachments on a person's teeth in accordance with one or more aspects of a treatment plan. An attachment placement device can include a body having at least one surface shaped to conform to one or more contours of an exterior surface of a tooth, an attachment mounting structure including the attachment, and a number of supports connecting the attachment to the body. In some embodiments, the body includes one or more cavities shaped to receive corresponding teeth of the dental arch to retain the attachment placement device in a predetermined position with respect to the dental arch and align the attachment to its intended position and orientation on the tooth surface. The attachment can then be secured to the tooth using bonding, adhesives, etc. The supports can then be cut, broken, or otherwise released to allow the attachment placement device to be removed while the attachment remains on the tooth. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used to make incremental palatal expanders and/or a series of incremental palatal expanders used to expand a person's palate from an initial position toward a target position in accordance with one or more aspects of a treatment plan. An incremental palatal expander can include a first tooth engagement region, a second tooth engagement region, and a palatal region connecting the first and second tooth engagement regions and configured to apply a lateral force between the first tooth engagement region and the second tooth engagement region. For instance, the first and second tooth engagement regions can be molar regions (which may also be configured to include premolars), each with one or more cavities that respectively fit over one of the patient's molars (and/or premolars). The palatal region can separate the tooth engagement regions and can fit against the patient's palate. The palatal region can provide force to stretch or expand the mid-palatal region, and can include springs, thermally active materials), struts, supports, cross-beams, ribs, gaps, windows, attachments, etc. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

### Example 1

A method comprising:
receiving a treatment plan for a patient's teeth, the treatment plan comprising a target arrangement for the teeth and a plurality of treatment stages configured to reposition the teeth from an initial arrangement toward the target arrangement;
determining a set of appliance parameters for a dental appliance configured to implement at least one treatment stage of the treatment plan;
determining a set of manufacturing parameters for a fabrication system to be used to additively manufacture the dental appliance; and
generating a 3D digital representation of an appliance geometry for the dental appliance, wherein the appliance geometry is configured to mitigate loss of fidelity at a target region of the dental appliance due to at least one manufacturing parameter of the fabrication system.

### Example 2

The method of Example 1, wherein the set of manufacturing parameters comprises one or more of the following: a minimum feature size, a maximum feature size, a minimum layer height, a maximum layer height, a print resolution, a print coordinate system, a print directionality, a print offset, a predicted amount of overcuring, a predicted amount of deformation, a predicted amount of material loss, or a predicted amount of residual material after cleaning.

### Example 3

The method of Example 1 or 2, wherein at least some of the manufacturing parameters correspond to an additive manufacturing process implemented by the fabrication system.

### Example 4

The method of Example 3, wherein the additive manufacturing process comprises digital light processing or stereolithography.

### Example 5

The method of Example 3 or 4, wherein the additive manufacturing process comprises forming the dental appliance from a curable material.

### Example 6

The method of any one of Examples 1 to 5, wherein at least some of the manufacturing parameters correspond to a post-processing operation implemented by the fabrication system.

### Example 7

The method of Example 6, wherein the post-processing operation comprises one or more of removing residual material, removing support structures, washing, post-curing, or annealing.

### Example 8

The method of any one of Examples 1 to 7, wherein the loss of fidelity comprises a deviation between an intended geometry for the target region and an actual geometry of the target region when the dental appliance is additively manufactured by the fabrication system.

### Example 9

The method of any one of Examples 1 to 8, wherein the loss of fidelity is at least partially due to a difference between a resolution of the 3D digital representation and a resolution of the fabrication system.

### Example 10

The method of any one of Examples 1 to 9, wherein the loss of fidelity is at least partially due to a misalignment between a coordinate system of the 3D digital representation and a coordinate system of the fabrication system.

### Example 11

The method of any one of Examples 1 to 10, wherein the loss of fidelity is at least partially due to an orientation of the target region relative to a print directionality of the fabrication system.

### Example 12

The method of any one of Examples 1 to 11, wherein generating the 3D digital representation of the appliance geometry comprises:
generating an initial geometry of the dental appliance based on the set of appliance parameters,
evaluating whether the target region is likely to experience the loss of fidelity when the dental appliance is additively manufactured, and
adjusting the initial geometry of the dental appliance to reduce the loss of fidelity at the target region.

### Example 13

The method of Example 12, wherein generating the initial geometry comprises:
identifying one or more appliance design rules for the appliance geometry, based on the set of appliance parameters, and
determining the initial geometry based on the one or more appliance design rules.

### Example 14

The method of Example 12 or 13, wherein evaluating whether the target region is likely to experience the loss of fidelity comprises predicting an actual geometry of the target region when the dental appliance is additively manufactured.

### Example 15

The method of any one of Examples 12 to 14, wherein evaluating whether the target region is likely to experience the loss of fidelity is performed based on one or more of simulation data, experimental data, a rule-based algorithm, or a machine learning algorithm.

### Example 16

The method of any one of Examples 12 to 15, wherein the initial geometry is adjusted by changing one or more of a position or a shape of an appliance feature of the target region.

### Example 17

The method of any one of Examples 12 to 16, wherein the initial geometry is adjusted by changing an orientation of the dental appliance.

### Example 18

The method of any one of Examples 12 to 17, wherein the initial geometry is adjusted by adding a support structure to the dental appliance.

### Example 19

The method of any one of Examples 1 to 18, further comprising generating a plurality of 2D cross-sections from the 3D digital representation.

### Example 20

The method of Example 19, further comprising generating an instruction file configured to cause the fabrication system to additively manufacture the dental appliance from a plurality of material layers corresponding to the plurality of 2D cross-sections.

### Example 21

The method of Example 19 or 20, wherein each 2D cross-section comprises a plurality of locations, each location associated with a print priority identifier.

### Example 22

The method of Example 21, wherein the print priority identifier comprises one or more of the following: whether the location is mandatory or optional to be printed, or whether the location is mandatory or optional to not be printed.

### Example 23

The method of any one of Examples 1 to 22, further comprising generating an instruction file configured to cause the fabrication system to additively manufacture a plurality of dental appliances, including the dental appliance having the appliance geometry.

### Example 24

The method of Example 23, wherein generating the instruction file comprises:
receiving, for each dental appliance of the plurality of dental appliances, a plurality of 2D cross-sections representing a plurality of layers for additively manufacturing the respective dental appliance, and
combining the plurality of 2D cross-sections for each dental appliance into a single digital layout, wherein the instruction file includes the single digital layout with the plurality of 2D cross-sections.

### Example 25

The method of Example 24, wherein:
each 2D cross-section of each dental appliances comprises a plurality of coordinate locations, each coordinate location associated with a print priority identifier, and
the method further comprises positioning the plurality of 2D cross-sections for each dental appliance within the single digital layout based on the corresponding print priority identifiers.

### Example 26

The method of any one of Examples 1 to 25, wherein the dental appliance is an attachment placement device configured to locate an attachment on a tooth of the patient, the attachment being configured to interact with an aligner to apply force to the tooth according to at least one treatment stage of the treatment plan.

### Example 27

The method of any one of Examples 1 to 26, wherein the dental appliance is an aligner configured to reposition the patient's teeth according to at least one treatment stage of the treatment plan.

### Example 28

A system comprising:
a processor; and
a memory operably coupled to the processor and storing instructions that, when executed by the processor, cause the system to perform operations comprising:
   receiving a treatment plan for a patient's teeth, the treatment plan comprising a target arrangement for the teeth and a plurality of treatment stages configured to reposition the teeth from an initial arrangement toward the target arrangement,
   determining a set of appliance parameters for a dental appliance configured to implement at least one treatment stage of the treatment plan,
   determining a set of manufacturing parameters for a fabrication system to be used to additively manufacture the dental appliance, and
   generating a 3D digital representation of an appliance geometry for the dental appliance, wherein the appliance geometry is configured to mitigate loss of fidelity at a target region of the dental appliance due to at least one manufacturing parameter of the fabrication system.

### Example 29

The system of Example 28, wherein the set of manufacturing parameters comprises one or more of the following: a minimum feature size, a maximum feature size, a minimum layer height, a maximum layer height, a print resolution, a print coordinate system, a print directionality, a print offset, a predicted amount of overcuring, a predicted amount of deformation, a predicted amount of material loss, or a predicted amount of residual material after cleaning.

### Example 30

The system of Example 28 or 29, wherein at least some of the manufacturing parameters correspond to an additive manufacturing process implemented by the fabrication system.

### Example 31

The system of Example 30, wherein the additive manufacturing process comprises digital light processing or stereolithography.

### Example 32

The system of Example 30 or 31, wherein the additive manufacturing process comprises forming the dental appliance from a curable material.

### Example 33

The system of any one of Examples 28 to 32, wherein at least some of the manufacturing parameters correspond to a post-processing operation implemented by the fabrication system.

### Example 34

The system of Example 33, wherein the post-processing operation comprises one or more of removing residual material, removing support structures, washing, post-curing, or annealing.

### Example 35

The system of any one of Examples 28 to 34, wherein the loss of fidelity comprises a deviation between an intended geometry for the target region and an actual geometry of the target region when the dental appliance is additively manufactured by the fabrication system.

### Example 36

The system of any one of Examples 28 to 35, wherein the loss of fidelity is at least partially due to a difference between a resolution of the 3D digital representation and a resolution of the fabrication system.

### Example 37

The system of any one of Examples 28 to 36, wherein the loss of fidelity is at least partially due to a misalignment between a coordinate system of the 3D digital representation and a coordinate system of the fabrication system.

### Example 38

The system of any one of Examples 28 to 37, wherein the loss of fidelity is at least partially due to an orientation of the target region relative to a print directionality of the fabrication system.

### Example 39

The system of any one of Examples 28 to 38, wherein generating the 3D digital representation of the appliance geometry comprises:
generating an initial geometry of the dental appliance based on the set of appliance parameters,
evaluating whether the target region is likely to experience the loss of fidelity when the dental appliance is additively manufactured, and
adjusting the initial geometry of the dental appliance to reduce the loss of fidelity at the target region.

### Example 40

The system of Example 39, wherein generating the initial geometry comprises:
identifying one or more appliance design rules for the appliance geometry, based on the set of appliance parameters, and
determining the initial geometry based on the one or more appliance design rules.

### Example 41

The system of Example 39 or 40, wherein evaluating whether the target region is likely to experience the loss of fidelity comprises predicting an actual geometry of the target region when the dental appliance is additively manufactured.

### Example 42

The system of any one of Examples 39 to 41, wherein evaluating whether the target region is likely to experience the loss of fidelity is performed based on one or more of simulation data, experimental data, a rule-based algorithm, or a machine learning algorithm.

### Example 43

The system of any one of Examples 39 to 42, wherein the initial geometry is adjusted by changing one or more of a position or a shape of an appliance feature of the target region.

### Example 44

The system of any one of Examples 39 to 43, wherein the initial geometry is adjusted by changing an orientation of the dental appliance.

### Example 45

The system of any one of Examples 39 to 44, wherein the initial geometry is adjusted by adding a support structure to the dental appliance.

### Example 46

The system of any one of Examples 28 to 45, wherein the operations further comprise generating a plurality of 2D cross-sections from the 3D digital representation.

### Example 47

The system of Example 46, wherein the operations further comprise generating an instruction file configured to cause the fabrication system to additively manufacture the dental appliance from a plurality of material layers corresponding to the plurality of 2D cross-sections.

### Example 48

The system of Example 46 or 47, wherein each 2D cross-section comprises a plurality of locations, each location associated with a print priority identifier.

### Example 49

The system of Example 48, wherein the print priority identifier comprises one or more of the following: whether the location is mandatory or optional to be printed, or whether the location is mandatory or optional to not be printed.

### Example 50

The system of any one of Examples 28 to 49, wherein the operations further comprise generating an instruction file configured to cause the fabrication system to additively manufacture a plurality of dental appliances, including the dental appliance having the appliance geometry.

### Example 51

The system of Example 50, wherein generating the instruction file comprises:
receiving, for each dental appliance of the plurality of dental appliances, a plurality of 2D cross-sections representing a plurality of layers for additively manufacturing the respective dental appliance, and
combining the plurality of 2D cross-sections for each dental appliance into a single digital layout, wherein the instruction file includes the single digital layout with the plurality of 2D cross-sections.

### Example 52

The system of Example 51, wherein:
each 2D cross-section of each dental appliances comprises a plurality of coordinate locations, each coordinate location associated with a print priority identifier, and
the method further comprises positioning the plurality of 2D cross-sections for each dental appliance within the single digital layout based on the corresponding print priority identifiers.

### Example 53

The system of any one of Examples 28 to 52, wherein the dental appliance is an attachment placement device configured to locate an attachment on a tooth of the patient, the attachment being configured to interact with an aligner to apply force to the tooth according to at least one treatment stage of the treatment plan.

### Example 54

The system of any one of Examples 28 to 53, wherein the dental appliance is an aligner configured to reposition the patient's teeth according to at least one treatment stage of the treatment plan.

### Example 55

A non-transitory computer-readable storage medium comprising instructions that, when executed by one or more processors of a computing system, cause the computing system to perform operations comprising the method of any one of any one of Examples 1 to 27.

### Conclusion

Although many of the embodiments are described above with respect to systems, devices, and methods for manufacturing dental appliances, the technology is applicable to other applications and/or other approaches, such as manufacturing other types of objects. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1-14.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A method comprising:
receiving a treatment plan for a patient's teeth, the treatment plan comprising a target arrangement for the teeth and a plurality of treatment stages configured to reposition the teeth from an initial arrangement toward the target arrangement;
determining a set of appliance parameters for a dental appliance configured to implement at least one treatment stage of the treatment plan;
determining a set of manufacturing parameters for a fabrication system to be used to additively manufacture the dental appliance; and
generating a 3D digital representation of an appliance geometry for the dental appliance, wherein the appliance geometry is configured to mitigate loss of fidelity at a target region of the dental appliance due to at least one manufacturing parameter of the fabrication system.

2. The method of claim 1, wherein the set of manufacturing parameters comprises one or more of the following: a minimum feature size, a maximum feature size, a minimum layer height, a maximum layer height, a print resolution, a print coordinate system, a print directionality, a print offset, a predicted amount of overcuring, a predicted amount of deformation, a predicted amount of material loss, or a predicted amount of residual material after cleaning.

3. The method of claim 1, wherein at least some of the manufacturing parameters correspond to an additive manufacturing process implemented by the fabrication system.

4. The method of claim 3, wherein the additive manufacturing process comprises digital light processing or stereolithography.

5. The method of claim 3, wherein the additive manufacturing process comprises forming the dental appliance from a curable material.

6. The method of claim 1, wherein at least some of the manufacturing parameters correspond to a post-processing operation implemented by the fabrication system.

7. The method of claim 6, wherein the post-processing operation comprises one or more of removing residual material, removing support structures, washing, post-curing, or annealing.

8. The method of claim 1, wherein the loss of fidelity comprises a deviation between an intended geometry for the target region and an actual geometry of the target region when the dental appliance is additively manufactured by the fabrication system.

9. The method of claim 1, wherein the loss of fidelity is at least partially due to a difference between a resolution of the 3D digital representation and a resolution of the fabrication system.

10. The method of claim 1, wherein the loss of fidelity is at least partially due to a misalignment between a coordinate system of the 3D digital representation and a coordinate system of the fabrication system.

11. The method of claim 1, wherein the loss of fidelity is at least partially due to an orientation of the target region relative to a print directionality of the fabrication system.

12. The method of claim 1, wherein generating the 3D digital representation of the appliance geometry comprises:
generating an initial geometry of the dental appliance based on the set of appliance parameters,
evaluating whether the target region is likely to experience the loss of fidelity when the dental appliance is additively manufactured, and
adjusting the initial geometry of the dental appliance to reduce the loss of fidelity at the target region.

13. The method of claim 12, wherein the initial geometry is adjusted by changing one or more of a position or a shape of an appliance feature of the target region.

14. The method of claim 12, wherein the initial geometry is adjusted by changing an orientation of the dental appliance.

15. The method of claim 12, wherein the initial geometry is adjusted by adding a support structure to the dental appliance.

16. The method of claim 1, further comprising generating a plurality of 2D cross-sections from the 3D digital representation.

17. The method of claim 16, further comprising generating an instruction file configured to cause the fabrication system to additively manufacture the dental appliance from a plurality of material layers corresponding to the plurality of 2D cross-sections.

18. The method of claim 16, wherein each 2D cross-section comprises a plurality of locations, each location associated with a print priority identifier.

19. The method of claim 18, wherein the print priority identifier comprises one or more of the following: whether the location is mandatory or optional to be printed, or whether the location is mandatory or optional to not be printed.

20. The method of claim 1, further comprising generating an instruction file configured to cause the fabrication system to additively manufacture a plurality of dental appliances, including the dental appliance having the appliance geometry.
